(19) United States
(12) Patent Application Publication
(10) Pub. No.: US 2017/0197455 A1
(43) Pub. Date: Jul. 13, 2017

(54) EASY-TO-HOLD OFF-AXIS PEN

(71) Applicants: BAO-SHEN LIU, NEW TAIPEI CITY (TW); YU-CHIA LIU, NEW TAIPEI CITY (TW); LIANLIN ZHANG, GANSU (CN)

(72) Inventor: BAO-SHEN LIU, NEW TAIPEI CITY (TW)

(21) Appl. No.: 15/314,236

(22) PCT Filed: Oct. 29, 2014
(86) PCT No.: PCT/CN2014/089833

§ 371 Date: Nov. 28, 2016

(30) Foreign Application Priority Data
May 30, 2014 (CN) 201410239723.7

(51) Int. Cl. B43K 23/08; B43K 3/00

(52) U.S. Cl. CPC B43K 23/08; B43K 3/00

(57) ABSTRACT

An easy-to-hold off-axis pen has a pen head, a barrel, and at least one forefinger support. The pen head is irregularly shaped and hollow. The barrel is connected with the pen head and is hollow to accommodate a cartridge and to be held. A detachable clip fastener is strip-shaped whose two ends are respectively disposed on the pen head and an off-axis part of the barrel. One end of the detachable clip fastener can be pulled by fingers. The at least one forefinger support is disposed on a sidewall of the off-axis part to support and locate the forefinger during writing. The present invention can further include middle finger abutments disposed on the off-axis part and thumb anti-slip parts disposed on the barrel to make the easy-to-hold off-axis pen easy to grasp and anti-slip, and make users comfortable to grasp.

### BACKGROUND OF THE INVENTION

1. Field of the Invention

The present invention relates to an off-axis pen, and more particularly to an easy-to-hold off-axis pen.

2. Description of Related Art

A conventional off-axis pen comprises a barrel and a writing end that are in different axes. The barrel has a held part close to the writing end. Users can grasp the held part of the off-axis pen to control the off-axis pen to write. The off-axis pen is ergonomic for users to grasp and sustain the writing end perpendicular to a writing surface to maintain the smoothness of writing. However, users must adjust the handheld gesture from time to time and the off-axis pen may deviate during the writing, causing the handheld gesture of users unable to be sustained and have no consistency. Therefore, users cannot get used to the handheld gesture and cannot develop a good habit of writing. Thus, the conventional off-axis pen still needs improvement.

### SUMMARY OF THE INVENTION

In light of the difficulty of adjusting the holding position on a conventional off-axis pen that causes different handheld gestures every time the off-axis pen is held, the objective of the invention is to provide an easy-to-hold off-axis pen which can quickly guide users to locate fingers on the easy-to-hold off-axis pen. The easy-to-hold off-axis pen has advantages of sustaining the handheld gesture and being suitable to be grasped for both right-handed and left-handed users.

To achieve the aforementioned objective, the easy-to-hold off-axis pen comprises a pen head, a barrel, and at least one forefinger support. The pen head is irregularly shaped and hollow. The barrel is hollow and tubular, and is connected with the pen head. Also, the barrel has an off-axis part, a held part, and a bottom part. An end of the off-axis part is disposed on the pen head. A protrusion is formed on the end of the off-axis part opposite to the pen head. The held part is disposed on the off-axis part near the protrusion. The held part and the off-axis part are in different axes. The bottom part is disposed on the held part opposite to the off-axis part. The at least one forefinger support is formed on a sidewall of the off-axis part and extends obliquely. A curved surface is formed on the at least one forefinger support and the protrusion.

Preferably, the invention further comprises at least one middle finger abutment. The at least one middle finger abutment is disposed on the barrel and is located on a junction of the off-axis part and the held part. The at least one middle finger abutment is formed backwardly relative to the protrusion.

Preferably, the invention further comprises at least one thumb anti-slip part. The at least one thumb anti-slip part is disposed on the barrel. The at least one thumb anti-slip part extends from an end of the off-axis part connected with the held part and toward the held part. A thickness and a width of the thumb anti-slip part increase along a direction toward the held part.

Preferably, the invention further comprises a pen cap. The pen cap is disposed on the pen head. The pen cap is hollow to accommodate the pen head, and has an open end and a closed end. A stylus part is disposed on the closed end of the pen cap.

Preferably, the invention further comprises a pen clip to make the easy-to-hold off-axis pen able to be clipped on pockets of clothes. The pen clip is disposed between the held part and the bottom part. The bottom part has a universal serial bus flash drive and the held part has a universal serial bus socket corresponding to the universal serial bus flash drive of the bottom part.

The invention of the easy-to-hold off-axis pen can achieve the effects of:

(1) The forefinger support, the thumb anti-slip part, and the middle finger abutment can respectively guide the user to locate the forefinger, thumb, and middle finger. The easy-to-hold off-axis pen can sustain the handheld gesture in consistency, and prevent the deviation of the barrel and the slipping of the fingers, and thus is beneficial to develop a good writing habit. The user only needs to apply force by the forefinger, and the barrel of the present invention will react with a counterforce on the thumb accordingly. Compared with the conventional uniaxial pen which needs to be held by applying force by three fingers at the same time, the present invention is more ergonomic and has better anti-slip effect. Due to the bilateral disposition of the forefinger supports, the thumb anti-slip parts, and the middle finger abutment, the present invention is suitable for both right-handed users and left-handed users.

(2) The disposition of the stylus part makes the present invention able to act as a stylus pen. Further, compared with a general stylus pen, the present invention is easier to hold by hand, is more ergonomic, and has fewer sight obstructions.

(3) When the bottom part and the held part respectively have a universal serial bus flash drive and a universal serial bus socket corresponding to each other, the easy-to-hold off-axis pen can have more functions. Besides, when the universal serial bus flash drive is inserted in the computer facility and left behind by a user, the user can easily recall due to the incompleteness of the easy-to-hold off-axis pen and timely retrieve the left-behind universal serial bus flash drive.

### BRIEF DESCRIPTION OF THE DRAWINGS

FIG. 1 is an exploded perspective view of a first embodiment of an easy-to-hold off-axis pen;

FIG. 2 is a perspective view of the first embodiment of the easy-to-hold off-axis pen;

FIG. 3 is a top view of the first embodiment of the easy-to-hold off-axis pen;

FIG. 4 is a sectional side view of the first embodiment of the easy-to-hold off-axis pen;

FIG. 5 is a first operational sectional side view of replacing a cartridge of the first embodiment of the easy-to-hold off-axis pen;

FIG. 6 is a partial enlarged view of FIG. 5;

FIG. 7 is a second operational sectional side view of replacing the cartridge of the first embodiment of the easy-to-hold off-axis pen;

FIG. 8 is a front view of the first embodiment of the easy-to-hold off-axis pen held by a right hand;

FIG. 9 is a front view of the first embodiment of the easy-to-hold off-axis pen held by a left hand;

FIG. 10 is a side view of the first embodiment of the easy-to-hold off-axis pen held by the right hand;

FIG. 11 is a side view of the first embodiment of the easy-to-hold off-axis pen held by the left hand;

FIG. 12 is a top view of the first embodiment of the easy-to-hold off-axis pen held by the right hand;

FIG. 13 is a top view of the first embodiment of the easy-to-hold off-axis pen held by the left hand;

FIG. 14 is a perspective view of a second embodiment of the easy-to-hold off-axis pen;

FIG. 15 is a front view of the second embodiment of the easy-to-hold off-axis pen held by the right hand;

FIG. 16 is a front view of the second embodiment of the easy-to-hold off-axis pen held by the left hand;

FIG. 17 is a side view of a third embodiment of the easy-to-hold off-axis pen;

FIG. 18 is a bottom view of the third embodiment of the easy-to-hold off-axis pen;

FIG. 19 is a front view of the third embodiment of the easy-to-hold off-axis pen held by the right hand;

FIG. 20 is a bottom view of the fourth embodiment of the easy-to-hold off-axis pen;

FIG. 21 is a bottom view of the fifth embodiment of the easy-to-hold off-axis pen;

FIG. 22A is a first external view of a middle finger abutment of the sixth embodiment of the easy-to-hold off-axis pen;

FIG. 22B is a second external view of the middle finger abutment of the sixth embodiment of the easy-to-hold off-axis pen;

FIG. 22C is a third external view of the middle finger abutment of the sixth embodiment of the easy-to-hold off-axis pen;

FIG. 22D is a fourth external view of the middle finger abutment of the sixth embodiment of the easy-to-hold off-axis pen;

FIG. 22E is a fifth external view of the middle finger abutment of the sixth embodiment of the easy-to-hold off-axis pen;

FIG. 22F is a sixth external view of the middle finger abutment of the sixth embodiment of the easy-to-hold off-axis pen;

FIG. 23 is an exploded perspective view of a pen clip of the seventh embodiment of the easy-to-hold off-axis pen;

FIG. 24 is another exploded perspective view of the pen clip in FIG. 23;

FIG. 25 is a side view of the easy-to-hold off-axis pen corresponding to FIG. 23;

FIG. 26 is a side view of the easy-to-hold off-axis pen corresponding to FIG. 24;

FIG. 27 is a front view of a seventh embodiment of the easy-to-hold off-axis pen held by the right hand;

FIG. 28 is a front view of a seventh embodiment of the easy-to-hold off-axis pen held by the left hand;

FIG. 29 is a bottom view of the pen cap of an eighth embodiment of the easy-to-hold off-axis pen;

FIG. 30 is a side view of the eighth embodiment of the easy-to-hold off-axis pen;

FIG. 31 is a side view of the eighth embodiment of the easy-to-hold off-axis pen with the pen cap deposited on the pen clip;

FIG. 32 is a top view of the eighth embodiment of the easy-to-hold off-axis pen with the pen clip disposed in one slot;

FIG. 33 is a top view of the eighth embodiment of the easy-to-hold off-axis pen with the pen clip disposed in another slot;

FIG. 34 is an exploded view of the ninth embodiment of the easy-to-hold off-axis pen;

FIG. 35 is a partial sectional side view of the ninth embodiment of the easy-to-hold off-axis pen;

FIG. 36 is an external view of the ninth embodiment of the easy-to-hold off-axis pen;

FIG. 37 is an exploded view of the tenth embodiment of the easy-to-hold off-axis pen;

FIG. 38A shows sectional side view of the tenth embodiment of the easy-to-hold off-axis pen;

FIG. 38B shows sectional bottom view of the tenth embodiment of the easy-to-hold off-axis pen;

FIG. 39 is an operational view of the tenth embodiment of the easy-to-hold off-axis pen with a touch panel;

FIG. 40 is another operational view of the tenth embodiment of the easy-to-hold off-axis pen held by the right hand with the touch panel;

FIG. 41 is an exploded sectional side view of an eleventh embodiment of the easy-to-hold off-axis pen;

FIG. 42 is a sectional side view of the eleventh embodiment of the easy-to-hold off-axis pen;

FIG. 43 is an operational sectional side view of replacing the cartridge of the eleventh embodiment of the easy-to-hold off-axis pen;

FIG. 44 is an external side view of the twelfth embodiment of the easy-to-hold off-axis pen;

FIG. 45 is an external side view of the thirteenth embodiment of the easy-to-hold off-axis pen;

FIG. 46 is an external side view of the fourteenth embodiment of the easy-to-hold off-axis pen;

FIG. 47 is an external side view of the fifteenth embodiment of the easy-to-hold off-axis pen;

FIG. 48 is an external side view of the sixteenth embodiment of the easy-to-hold off-axis pen;

FIG. 49 is an external side view of the seventeenth embodiment of the easy-to-hold off-axis pen;

FIG. 50 is an exploded side view of the eighteenth embodiment of the easy-to-hold off-axis pen;

FIG. 51 is an adjusting operational bottom view of the eighteenth embodiment of the easy-to-hold off-axis pen;

FIG. 52 is an integrated bottom view of the nineteenth embodiment of the easy-to-hold off-axis pen;

FIG. 53 is an operational bottom view of the nineteenth embodiment of the easy-to-hold off-axis pen;

FIG. 54 is a sectional side view of the pen cap of the twentieth embodiment of the easy-to-hold off-axis pen;

FIG. 55 is a partial exploded view of the twenty-first embodiment of the easy-to-hold off-axis pen;

FIG. 56 is a perspective view of the twenty-first embodiment of the easy-to-hold off-axis pen; and

FIG. 57 is a side view of the twenty-second embodiment of the easy-to-hold off-axis pen.

### DETAILED DESCRIPTION OF THE PREFERRED EMBODIMENT

With the accompanying drawings and preferred embodiments, technical features for achieving the objectives of the present invention will be described.

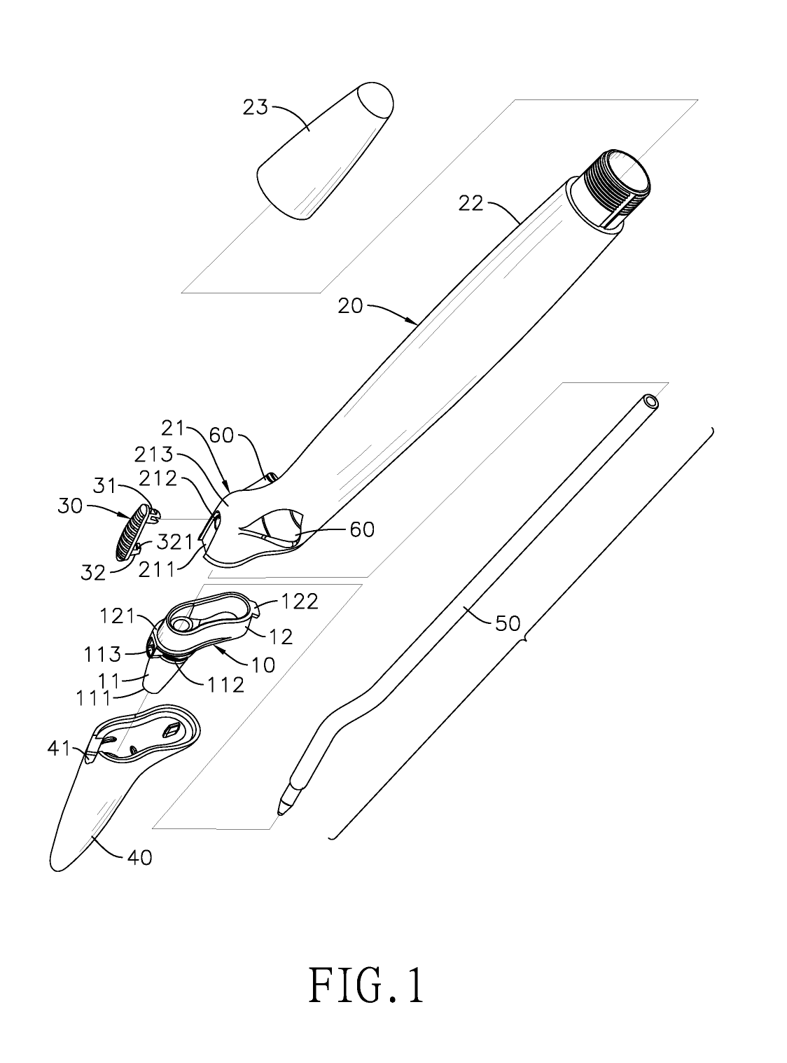

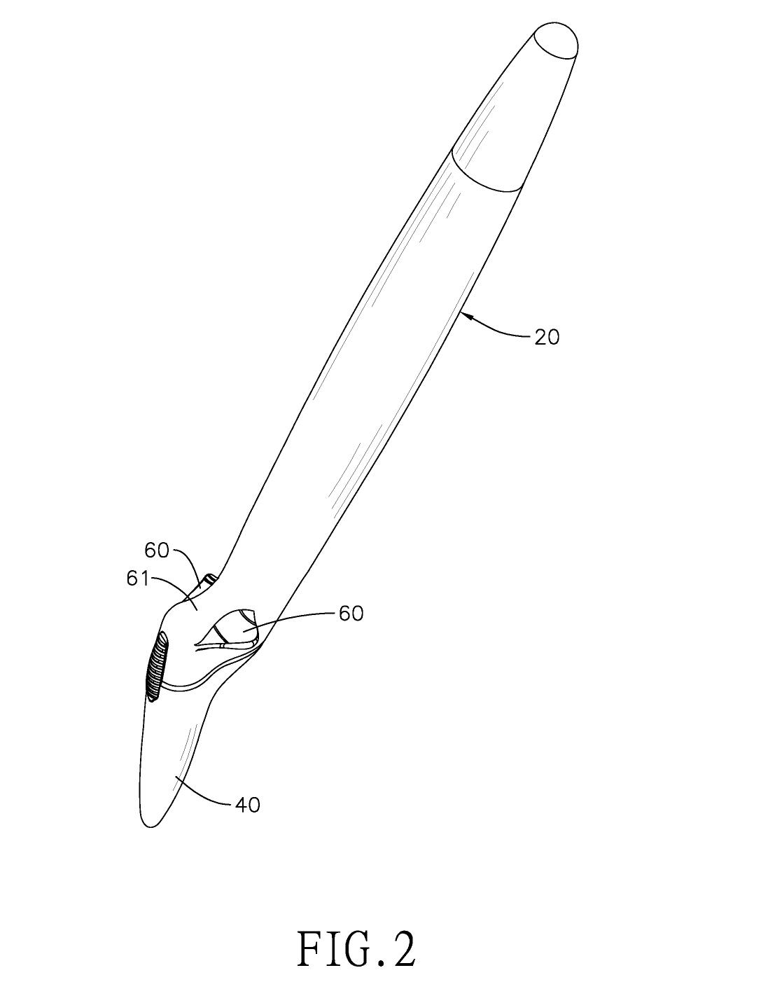

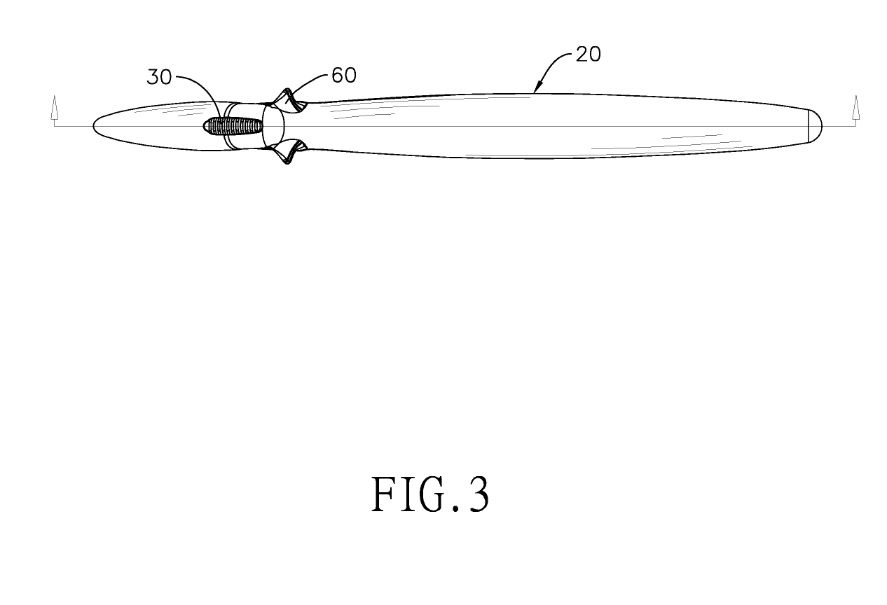

With reference to FIGS. 1 to 5, the easy-to-hold off-axis pen has a pen head 10, a barrel 20, a detachable clip fastener 30, a pen cap 40, a cartridge 50, and at least one forefinger support 60.

The pen head 10 is irregularly shaped and has a writing end 11 and a connecting end 12. The writing end 11 of the pen head 10 has an opening 111, a projection 112, and an aperture 113. The opening 111 is formed through the pen head 10 and accommodates the cartridge 50. The projection 112 is formed on an outer wall of the writing end 11. The aperture 113 is formed through the projection 112. The aperture 113 has a fixing hole 1131 formed near the opening 111 to position the detachable clip fastener 30. Preferably, the aperture 113 communicates with the opening 111. The fixing hole 1131 is formed on the wall of the aperture 113 and communicates with the opening 111. The connecting end 12 of the pen head 10 has a peripheral edge 121 near the aperture 113. A sectional area of the connecting end 12 is larger than a sectional area of the writing end 11.

The barrel 20 is connected with the connecting end 12 of the pen head 10. The barrel 20 is hollow and tubular, and has an open end and a closed end. The barrel has an off-axis part 21, a held part 22, and a bottom part 23. The off-axis part 21 is irregularly shaped and hollow. An end of the off-axis part 21 is disposed on the connecting end 12 of the pen head 10 and abuts the peripheral edge 121. A shape of the end of the off-axis part 21 is corresponding to a shape of the connecting end 12 of the pen head 10. The off-axis part 21 can have tenons and the connecting part 12 can have mortises corresponding to the tenons of the off-axis part 21 to enhance the connection. Or, the off-axis part 21 can have mortises and the connecting part 12 can have tenons corresponding to the mortises of the off-axis part 21 to enhance the connection. The off-axis part 21 has a notch 211, a locating hole 212, and a protrusion 213. In the embodiment, the notch 211 accommodates a bump 122, which is formed on the connecting end 12. The locating hole 212 is formed on the notch 211 and is formed through the off-axis part 21. The protrusion 213 is formed on the end of the off-axis part 21 opposite to the pen head 10. The held part 22 is connected with an end of the off-axis part 21 near the protrusion 213 and can be held by users. The held part 22 and the off-axis part 21 are in different axes. In the embodiment, the held part 22 and the off-axis part 21 are integrated. An end of the held part 22 opposite to the off-axis part 21 has a screw. The bottom part 23 is connected with the held part 22 on the end opposite to the off-axis part 21. The bottom part 23 has a screw corresponding to the screw of the held part 22. Specifically, the bottom part 23 and the held part 22 are connected to each other by the corresponding screws. In another embodiment, the off-axis part 21, the held part 22, and the bottom part 23 can be integrated.

The detachable clip fastener 30 is strip-shaped. The detachable clip fastener 30 is detachably disposed on the pen head 10 and the barrel 20. The detachable clip fastener 30 has a locating bump 31 and a fixing bump 32. The locating bump 31 is disposed in the locating hole 212 of the off-axis part 21 to make the detachable clip fastener 30 disposed in the notch 211. The fixing bump 32 is located on the detachable clip fastener 30 opposite to the locating bump 31. The fixing bump 32 has a free end and a non-free end which are opposite to each other. The free end is farther from the detachable clip fastener 30 than the non-free end. A periphery of the free end of the fixing bump 32 is longer than a periphery of the non-free end of the fixing bump 32. The non-free end of the fixing bump 32 is separated to two parts to have elasticity for compression. The fixing bump 32 is disposed on the pen head 10. The fixing bump 32 has a fixing part 321 disposed in the fixing hole 1131 of the aperture 113 to enhance the connection of the pen head 10 and the barrel 20. The detachable clip fastener 30 can be detached by pulling an end of the detachable clip fastener 30 near the fixing bump 32.

The pen cap 40 is hollow and has an open end and a closed end. The pen cap 40 is disposed on the writing end 11 of the pen head 10. A shape of the pen cap 40 is corresponding to a shape of the writing end 11 of the pen head 10 to enable the pen cap 40 to dispose on the writing end 11 of the pen head 10. In another embodiment, an inner wall of the pen cap 40 has tenons and the outer wall of the writing end 11 has mortises corresponding to the tenons of the inner wall to enhance the connection of the pen cap 40 and the pen head 10. Or, the inner wall of the pen cap 40 has mortises and the outer wall of the writing end 11 has tenons corresponding to the mortises of the inner wall to enhance the connection of the pen cap 40 and the pen head 10. The open end of the pen cap 40 has a breach 41 to accommodate the end of the detachable clip fastener 30 near the fixing bump 32.

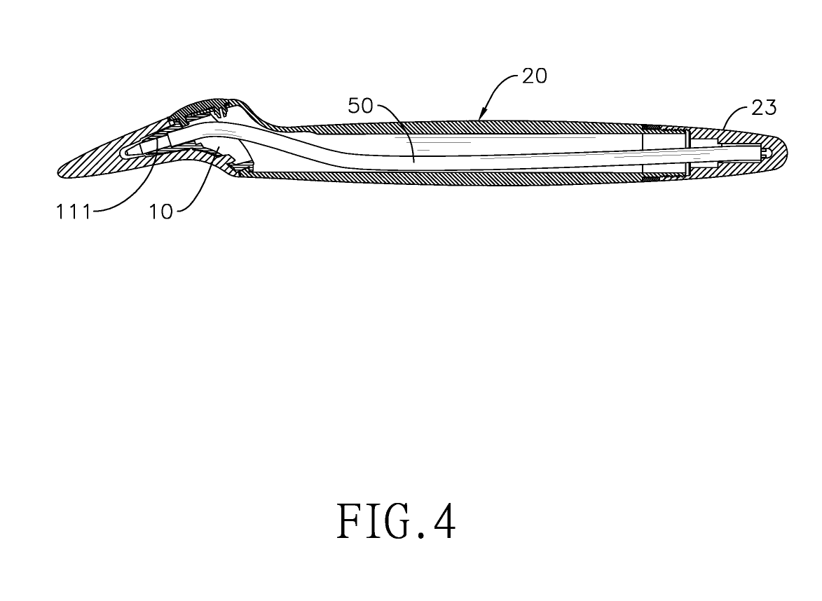

With reference to FIG. 4, the cartridge 50 is disposed through the pen head 10 and the barrel 20. One end of the cartridge 50 passes through the opening 111 of the pen head 10 and the other end of the cartridge 50 abuts the bottom part 23 of the barrel 20.

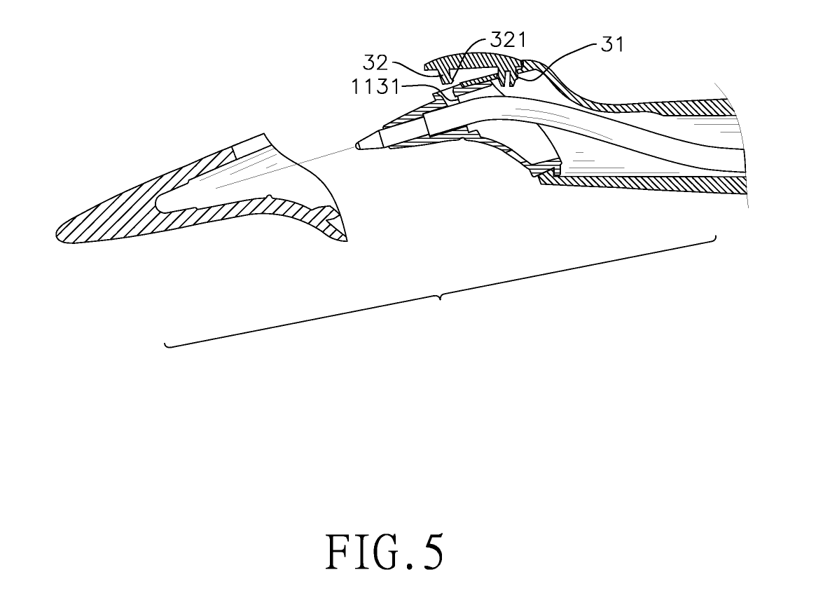

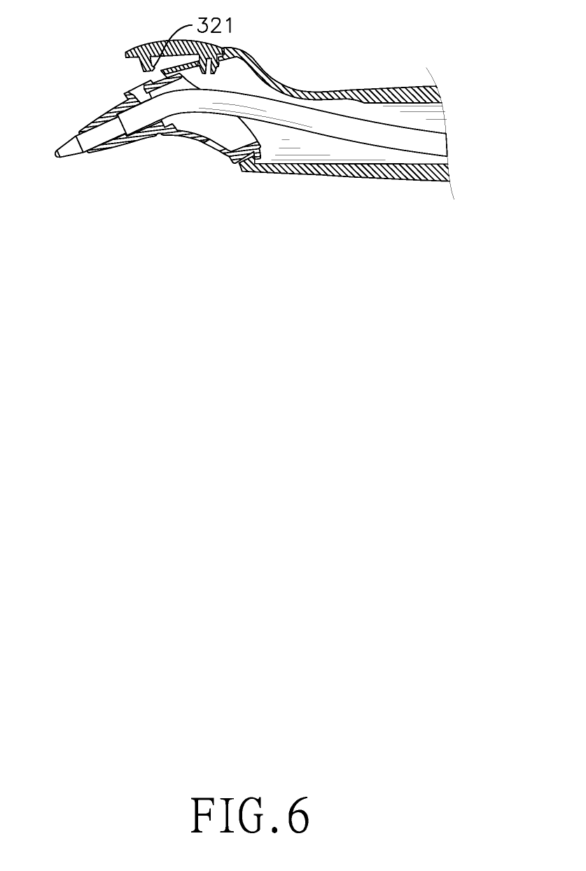

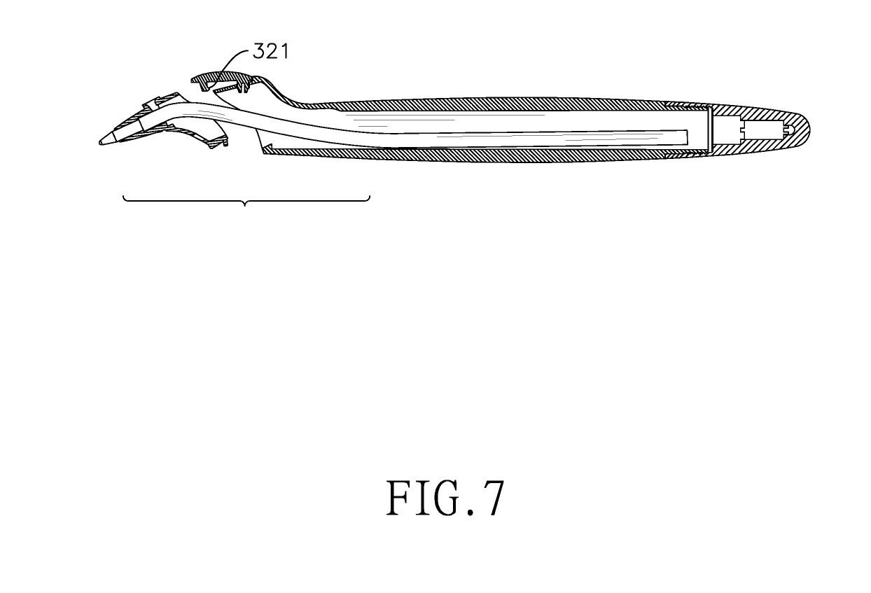

With reference to FIGS. 5 to 7, when the cartridge 50 needs to be replaced, the pen cap 40 needs to be detached from the pen head 10 at first. Following that, the end of the detachable clip fastener 30 is pulled near the fixing bump 32 to depart the fixing part 321 of the fixing bump 32 from the fixing hole 1131, thereby separating the pen cap 10 with the cartridge 50 from the barrel 20. After replacing a new cartridge 50, the off-axial part 21 of the barrel 20 is connected with the connecting end 12 of the pen head 10 and the fixing bump 32 is disposed in the aperture 113 to assemble the barrel 20 and the pen head 10. Therefore, the replacement of the cartridge 50 is completed and the steps of replacing the cartridge 50 are easy and convenient.

With reference to FIGS. 1 to 3, the at least one forefinger support 60 is formed on a sidewall of the off-axis part 21 and extends obliquely to support the forefinger of a user. A curved surface 61 is formed on the at least one forefinger support 60 and the protrusion 213. In the embodiment, the at least one forefinger support 60 includes two forefinger supports 60. The forefinger supports 60 are triangles and are located bilaterally to respectively support the forefinger of a right-handed user and the forefinger of a left-handed user. In another embodiment, only one forefinger support 60 is formed on the off-axis part 21. According to the pen-holding habit of users, the forefinger support 60 can be abutted by the forefinger of a right-handed user or the forefinger of a left-handed user. The connection method between the forefinger supports 60 and the off-axis part 21 is not limited as mentioned. The forefinger supports 60 can also be formed integrally on the off-axis part 21 and protrude from the off-axis part 21 and have the curved surface 61 to support the forefinger.

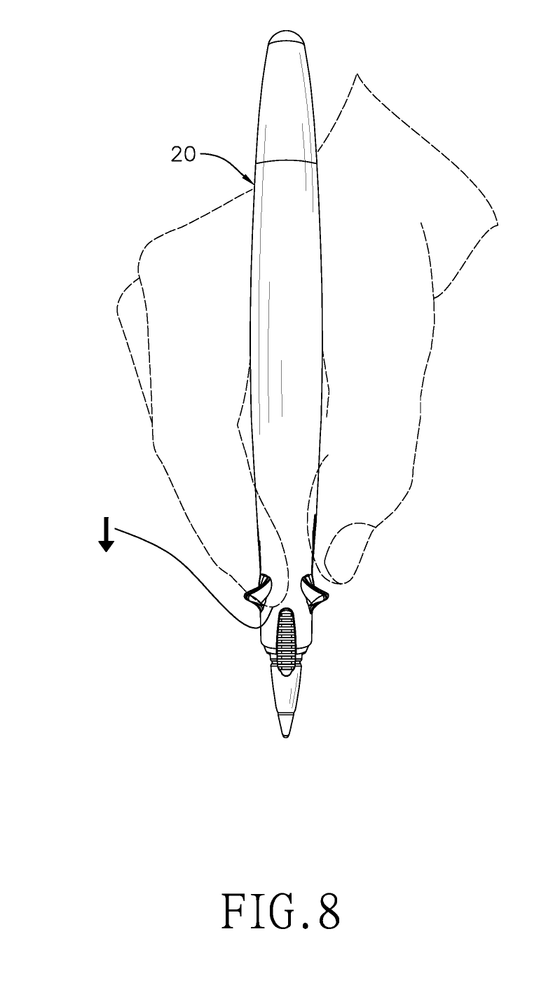

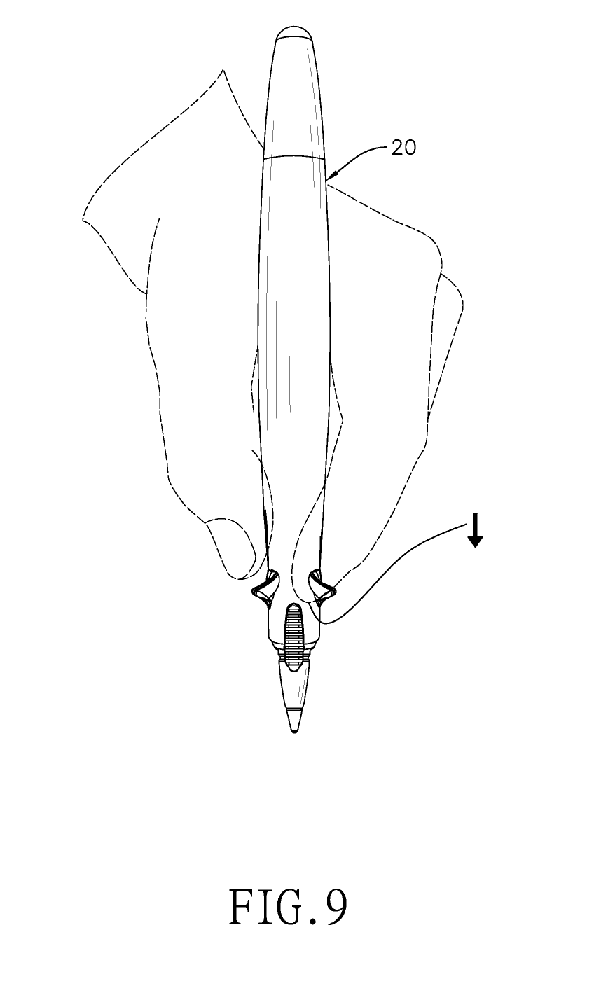

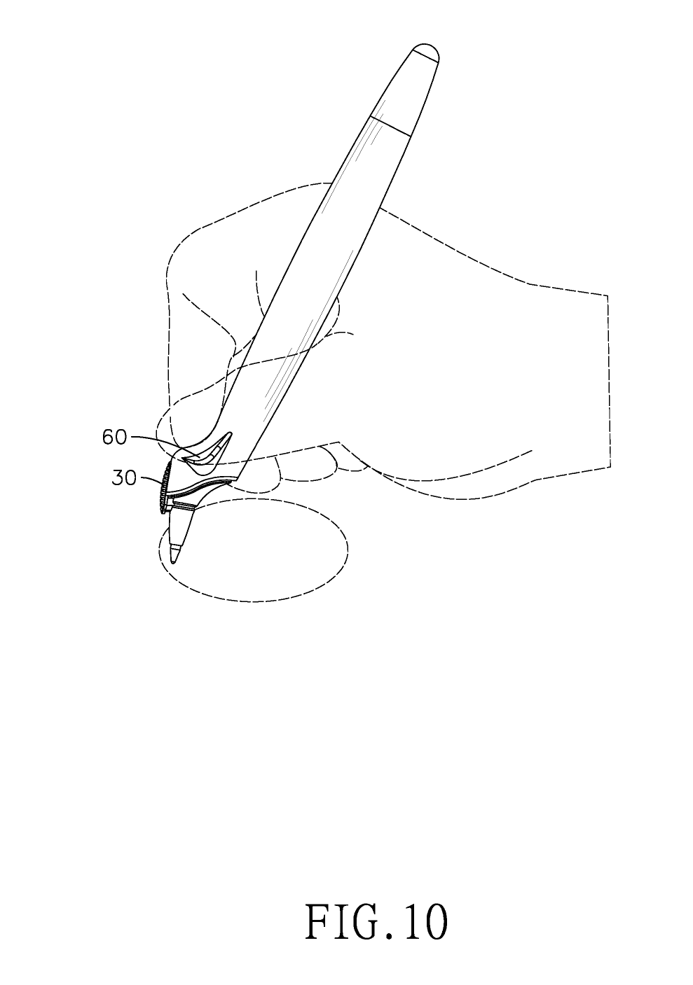

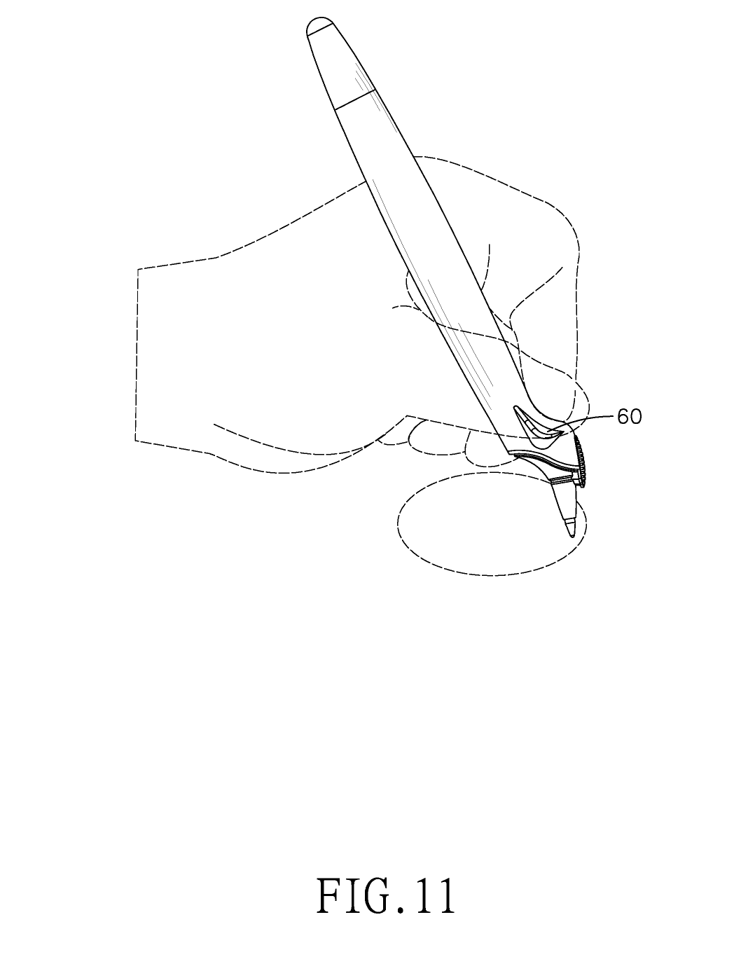

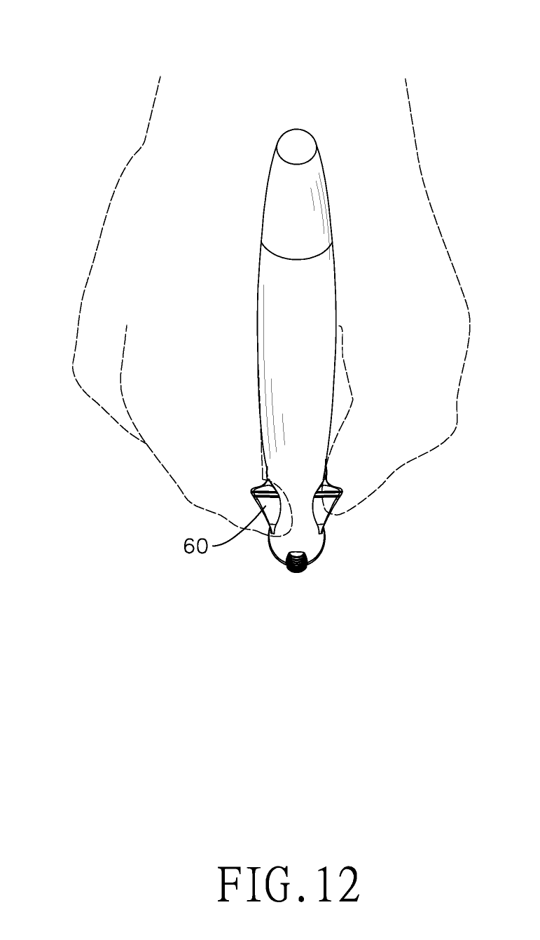

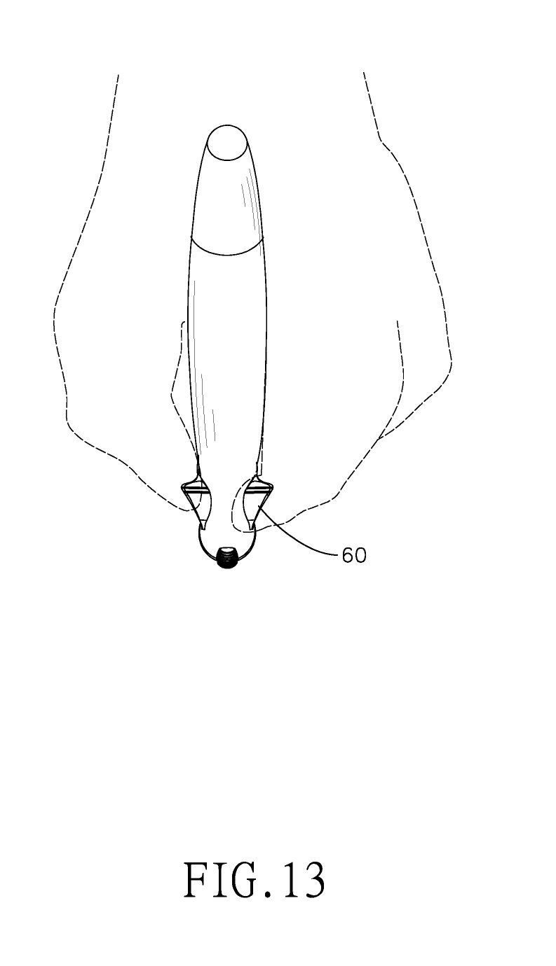

With reference to FIGS. 8, 10, and 12, the easy-to-hold off-axis pen is held by a right hand. An upper end of the barrel 20 abuts the purlicue and a lower end of the barrel 20 abuts the middle finger, the thumb, and the forefinger to control the moving of the easy-to-hold off-axis pen. The forefinger abuts the curved surface 61 of the corresponding forefinger support 60. When the forefinger applies force on the forefinger support 60 (an arrow representing the direction of the force in FIG. 8), the easy-to-hold off-axis pen reacts with a counterforce to prevent the thumb from sliding down. Compared with the conventional uniaxial pen which needs to be held and applied force by the thumb, the forefinger, and the middle finger, the present invention only needs to be applied with a slight force, thereby being more comfortable to hold and having better anti-slip effect. Besides, the deposition of the forefinger support 60 makes the forefinger more comfortable and do not need to abut on the off-axis part 21 intentionally. With reference to FIGS. 9, 11, and 13, the easy-to-hold off-axis pen is held by a left hand. The forefinger pulp abuts the curved surface 61 of the corresponding forefinger support 60. Because of the disposition of the two bilateral forefinger supports 60 in the embodiment, the present invention is suitable for both right-handed users and left-handed users.

Because the detachable clip fastener 30 and the forefinger supports 60 are respectively disposed on front and bilateral sides of the off-axis part 21 of the barrel 20, when using the easy-to-hold off-axis pen, both right-handed users and left-hand users will not be influenced by the detachable clip fastener 30.

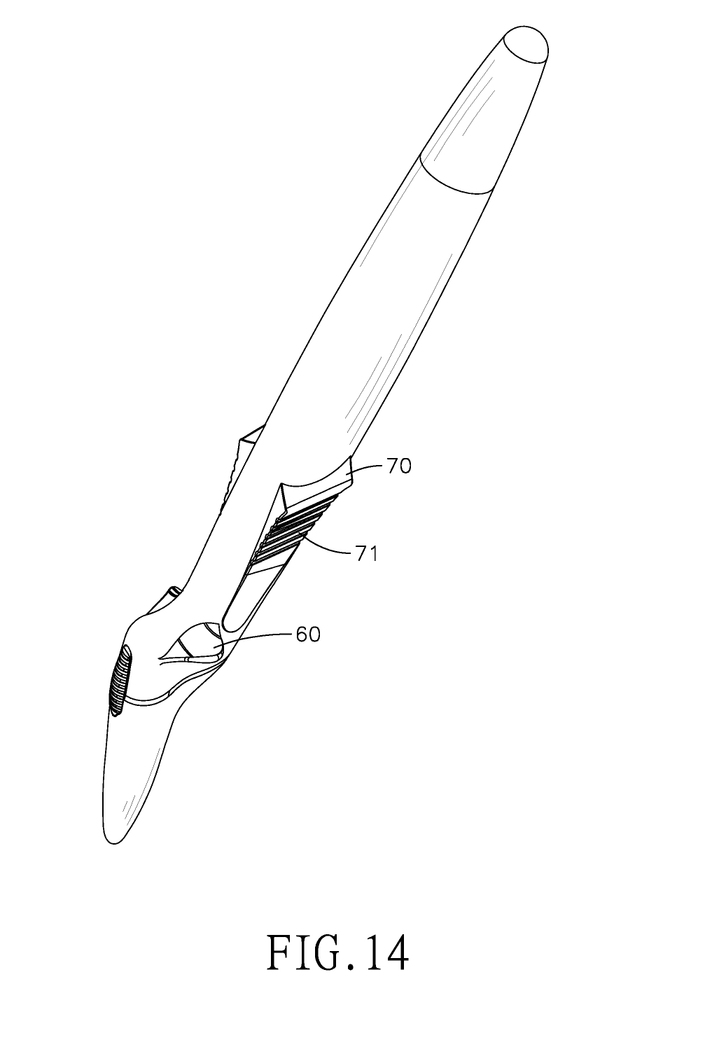

With reference to FIG. 14, the present invention further has at least one thumb anti-slip part 70. The at least one thumb anti-slip part 70 is disposed on the off-axis part 21 of the barrel 20 to prevent the thumb from slipping from the barrel 20 due to sweat. Specifically, the at least one thumb anti-slip part 70 extends from the end of the off-axis part 21 connected with the held part 22 and toward the held part 22. A thickness of the at least one thumb anti-slip part 70 and a width of the at least one thumb anti-slip part 70 increase along a direction toward the held part 22. The at least one thumb anti-slip part 70 is wedge-shaped and is made of relatively soft material such as rubber. The at least one thumb anti-slip part 70 can be detachably disposed on the barrel 20. For example, the at least one thumb anti-slip part 70 can have tenons and the barrel 20 can have mortises corresponding to the tenons of the at least one thumb anti-slip part 70 for assembly, or the at least one thumb anti-slip part 70 can have mortises and the barrel 20 can have tenons corresponding to the mortises of the at least one thumb anti-slip part 70 for assembly, or the at least one thumb anti-slip part 70 is fixed on the barrel 20 by glue, or the at least one thumb anti-slip part 70 and the barrel 20 are formed integrally. The at least one thumb anti-slip part 70 includes multiple oblique anti-slip strips 71.

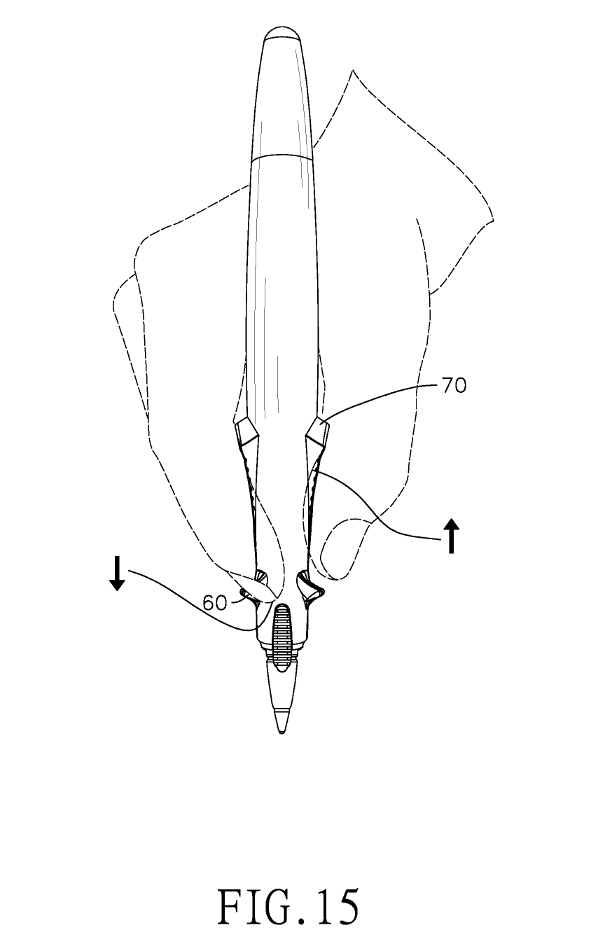

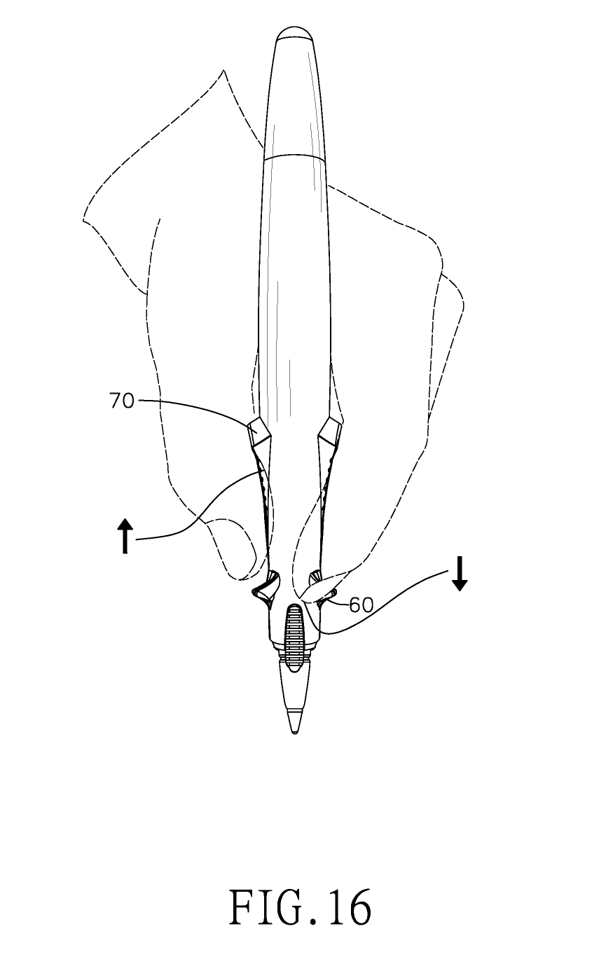

With reference to FIGS. 15 and 16, which respectively show situations of the easy-to-hold off-axis pen being held by the right hand and by the left hand. No matter held by the right hand or the left hand, the forefinger abuts the curved surface 61 of the forefinger support 60 and the thumb abuts the thumb anti-slip part 70. When the forefinger applies a force on the forefinger support 60 (a down arrow representing the direction of the force in FIGS. 15 and 16), the easy-to-hold off-axis pen reacts with a counterforce through the thumb anti-slip part 70 (an up arrow representing the direction of the force in FIGS. 15 and 16). At the same time, due to the disposition of the thumb anti-slip part 70, the thumb has a larger contact area on the easy-to-hold off-axis pen, and therefore the thumb anti-slip part 70 is efficient to prevent the thumb from slipping down. According to FIGS. 15 and 16, the staggered disposition of the forefinger supports 60 and the thumb anti-slip parts 70 make the easy-to-hold off-axis pen easily held and anti-slippery.

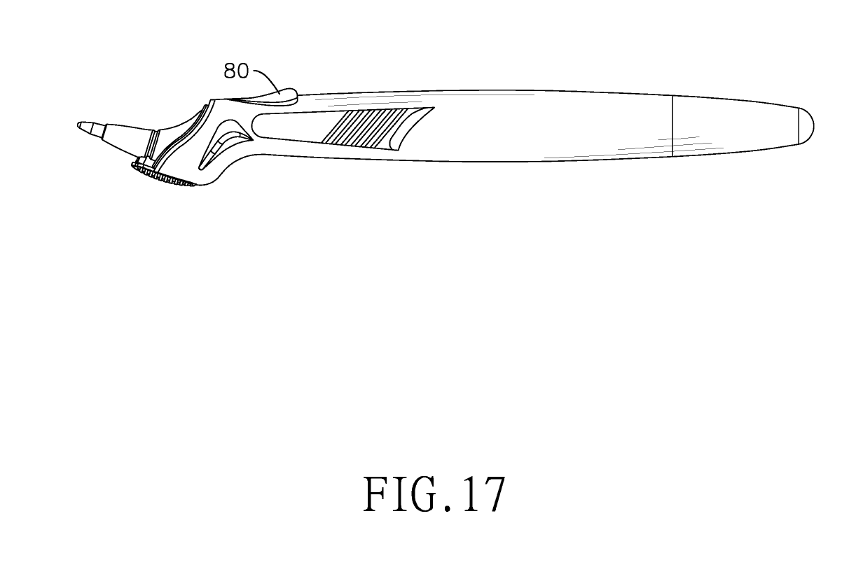

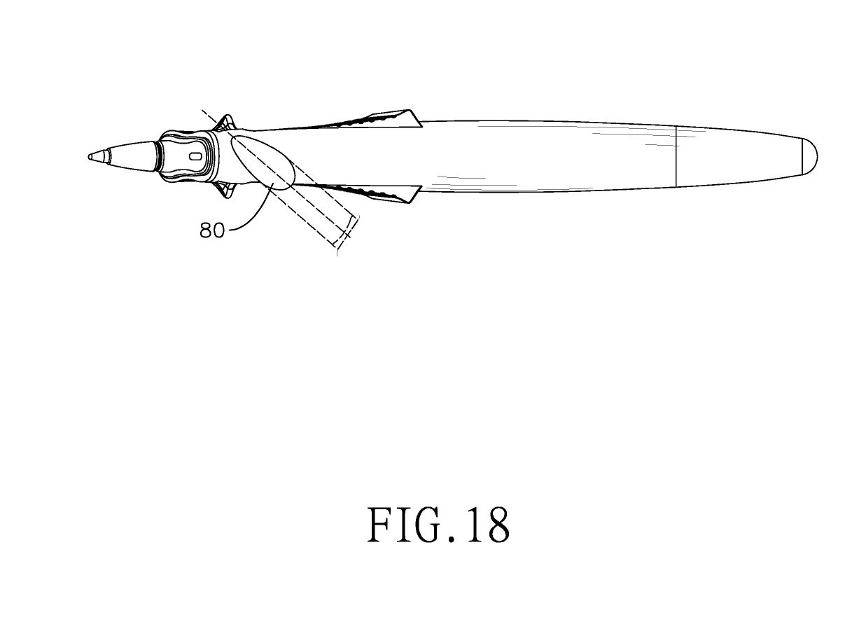

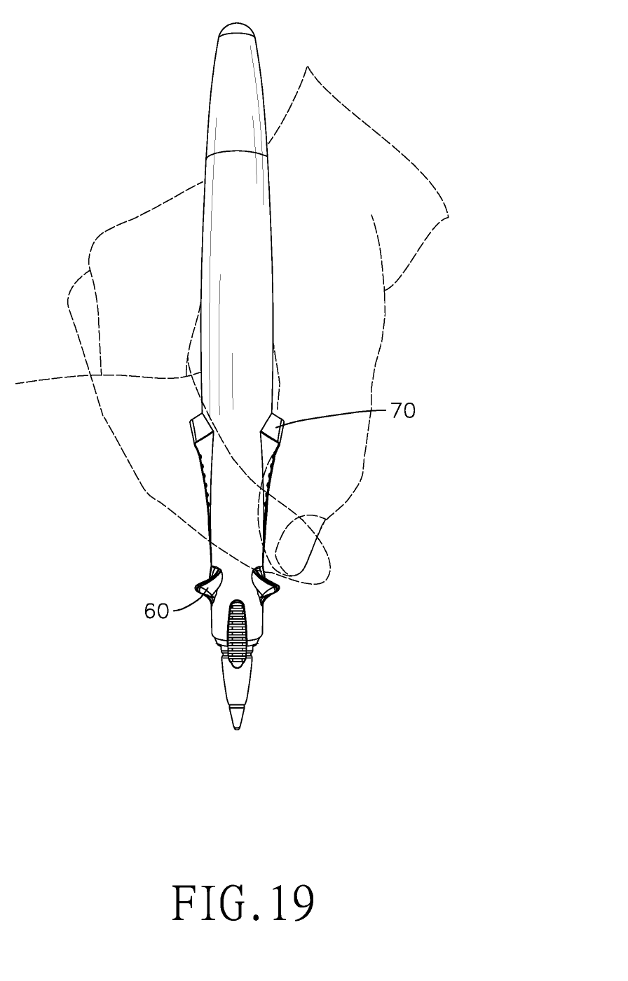

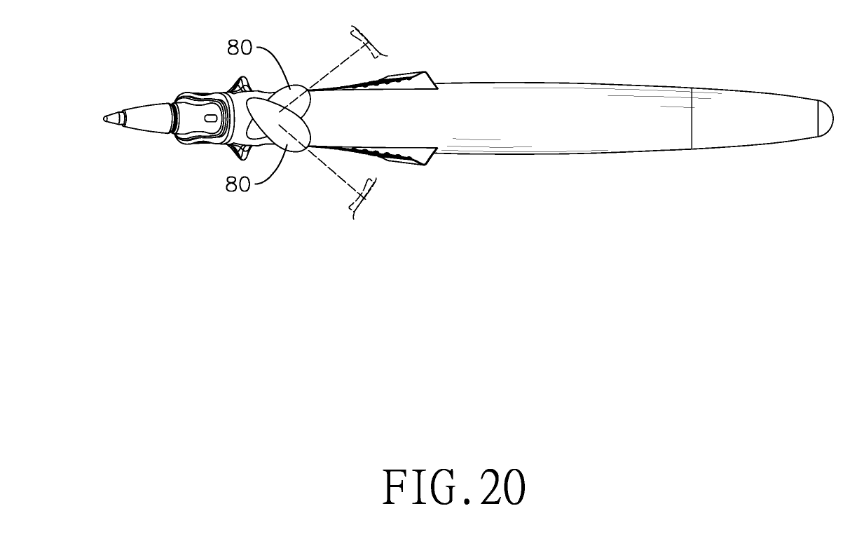

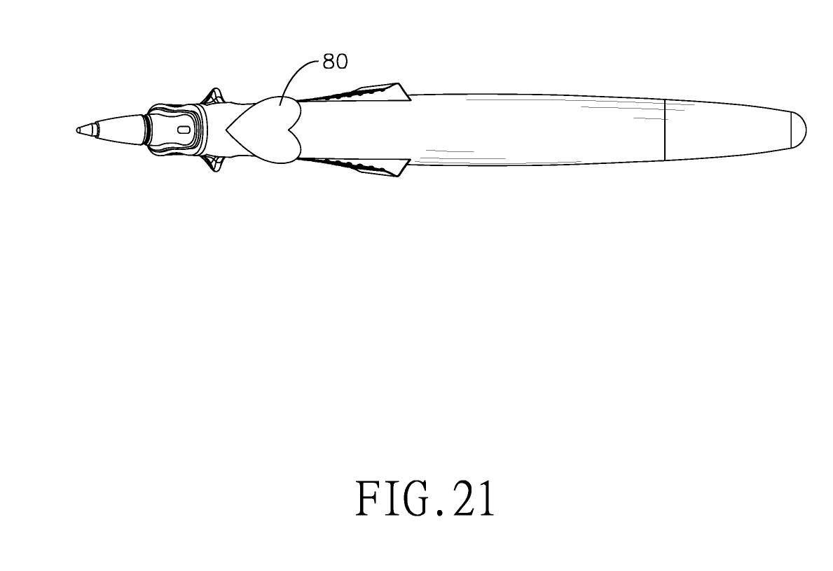

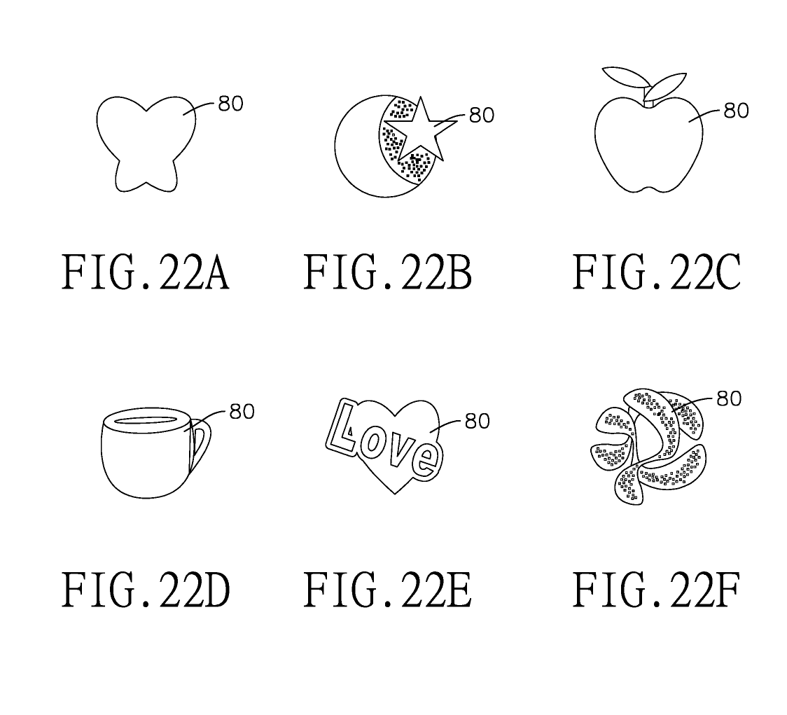

With reference to FIGS. 17 to 19, the easy-to-hold off-axis pen has at least one middle finger abutment 80. The at least one middle finger abutment 80 is obliquely disposed on the barrel 20 and is on the location in contact with the middle finger. Specially, the at least one middle finger abutment 80 is located on a junction of the off-axis part 21 and the held part 22 and is formed backwardly relative to the protrusion 213. According to a trigonometric projective measurement in FIG. 18, a surface of the at least one middle finger abutment 80 is concave to allow the middle finger to abut the at least one middle finger abutment 80. In the embodiment, the at least one middle finger abutment 80 includes one middle finger abutment 80. An oblique direction of the middle finger abutment 80 is corresponding to an oblique direction of the middle finger when the easy-to-hold off-axis pen is held by the right hand. Therefore, the easy-to-hold off-axis pen in the embodiment is suitable to be held by the right hand. With reference to FIG. 20, the at least one middle finger abutment 80 includes two bilateral middle finger abutments 80 which cross each other in a shape resembling a butterfly. Or, with reference to FIG. 21, the at least one middle finger abutment 80 includes a middle finger abutment 80 in a heart shape formed integrally. With reference to FIGS. 22A to 22F, the shape of the middle finger abutment 80 can be a butterfly, a tomato, an apple, a cup, a heart with characters, or a flower. In another embodiment, the shape of the middle finger abutment 80 also can be animals, plants, daily commodities, letters, or clothes. Shapes of the middle finger abutment 80 can change as desired; preferably, the shape of the middle finger abutment 80 is a heart. The middle finger abutment 80 is made of soft material and is formed integrally. In another embodiment, the middle finger abutment 80 is detachably disposed on the easy-to-hold off-axis pen. The middle finger abutment 80 can have tenons and the barrel 20 can have mortises corresponding to the tenons of the middle finger abutment 80 to assemble; or, the middle finger abutment 80 can have mortises and the barrel 20 can have tenons corresponding to the mortises of the middle finger abutment 80 to assemble.

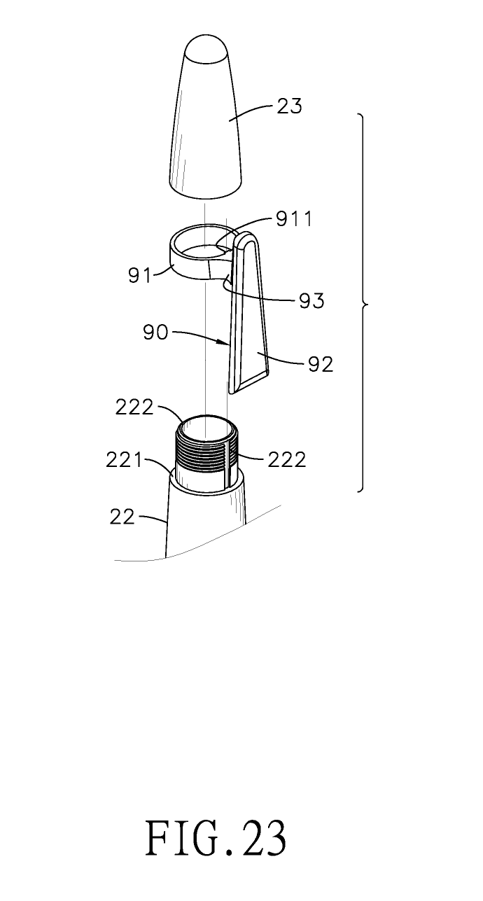

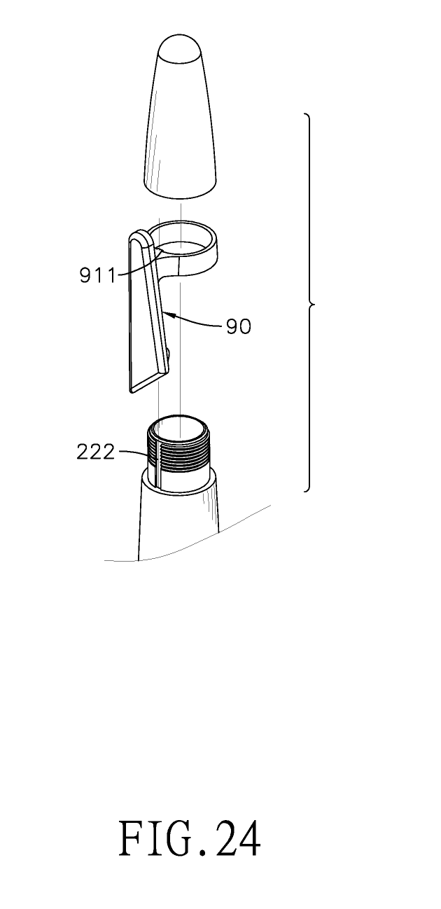

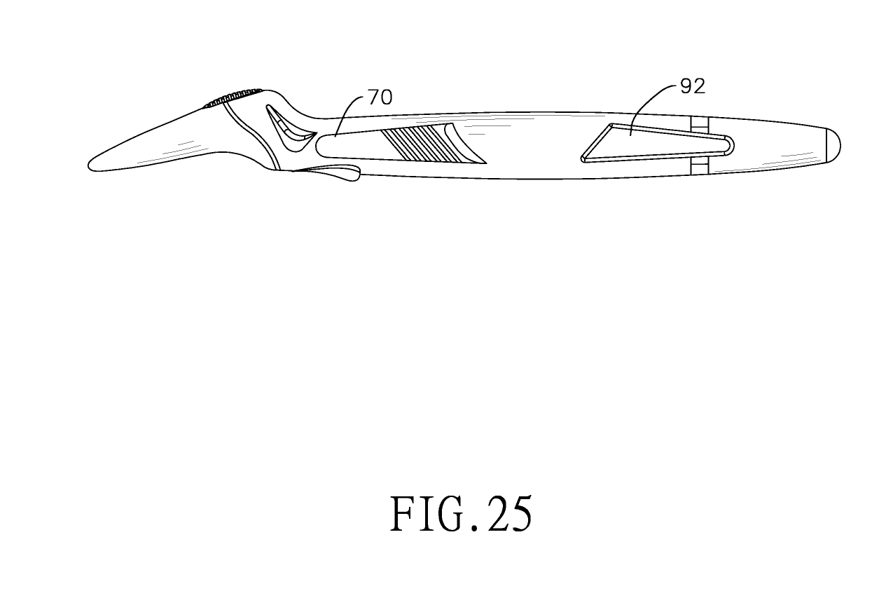

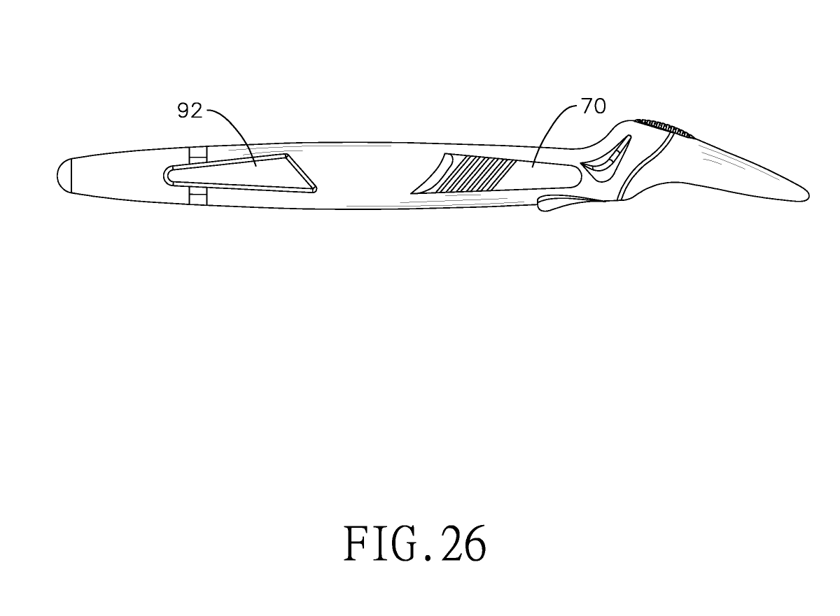

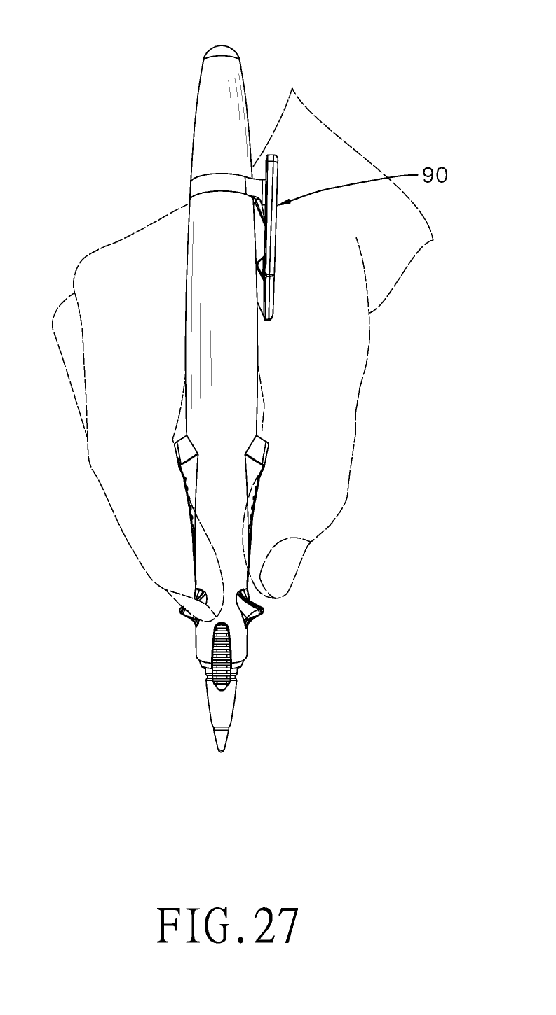

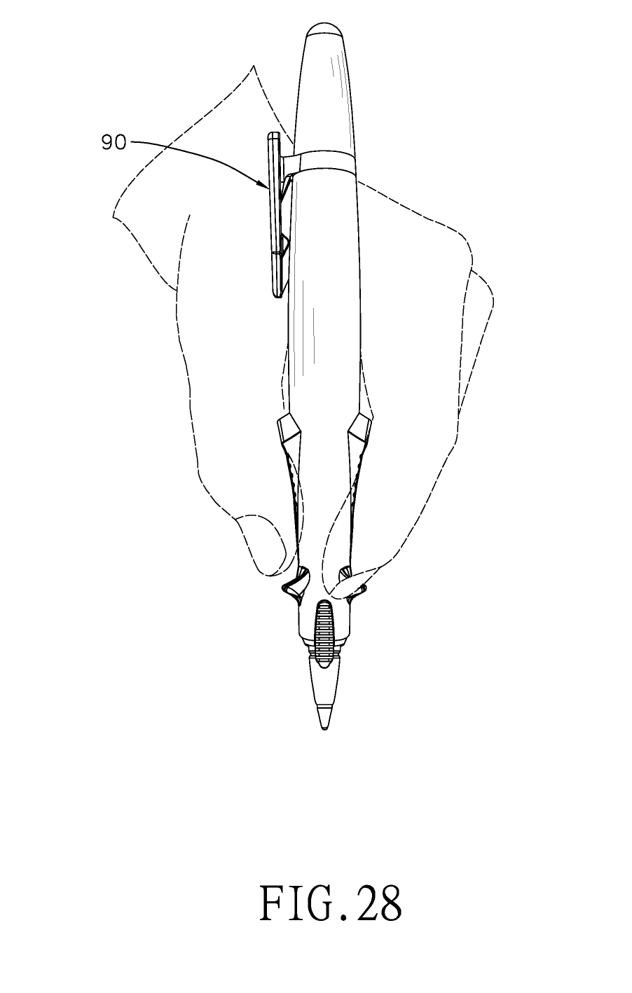

With reference to FIGS. 23 and 24, an end of the held part 22 is formed with two slots 222. The slots 222 are disposed bilaterally. To make the easy-to-hold off-axis pen easy to carry and fasten on the pocket of the clothes, the barrel 20 further has a pen clip 90. The pen clip 90 has a clip ring 91 and a clip part 92. The clip ring 91 is round and is disposed between the held part 22 and the bottom part 23. Specifically, the clip ring 91 can be disposed on the top of the held part 22 or can be disposed on the bottom of the bottom part 23. The clip ring 91 further has a rib 911 formed on an inner wall of the clip ring 91. The rib 911 is corresponding to the slots 222 of the held part 22. According to the right-handed users or the left-handed users, the rib 911 can be selectively disposed in one of the two slots 222. The clip part 92 is disposed on the clip ring 91 and is strip-shaped. With reference to FIGS. 25 and 27, when the easy-to-hold off-axis pen is held by the right hand, the rib 911 is disposed in the left slot 222 from the view of the user corresponding to the left thumb anti-slip part 70. With reference to FIGS. 26 and 28, when the easy-to-hold off-axis pen is held by the left hand, the rib 911 is disposed in the right slot 222 from the view of the user corresponding to the right thumb anti-slip part 70. Therefore, no matter which hand holds the easy-to-hold off-axis pen, the pen clip 90 is far from the thumb so the pen clip 90 does not influence the handheld gesture. Besides, changing the direction of the pen clip 90 is convenient and precise.

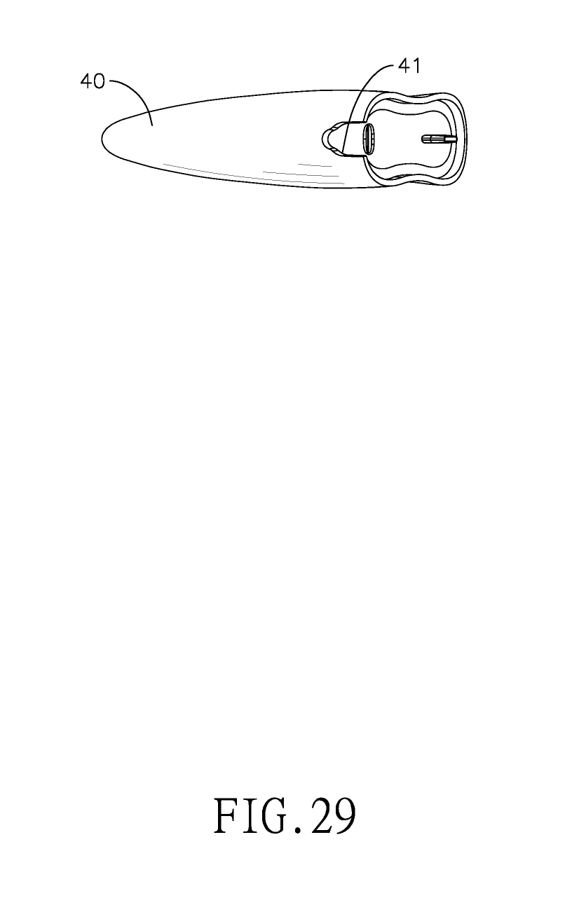

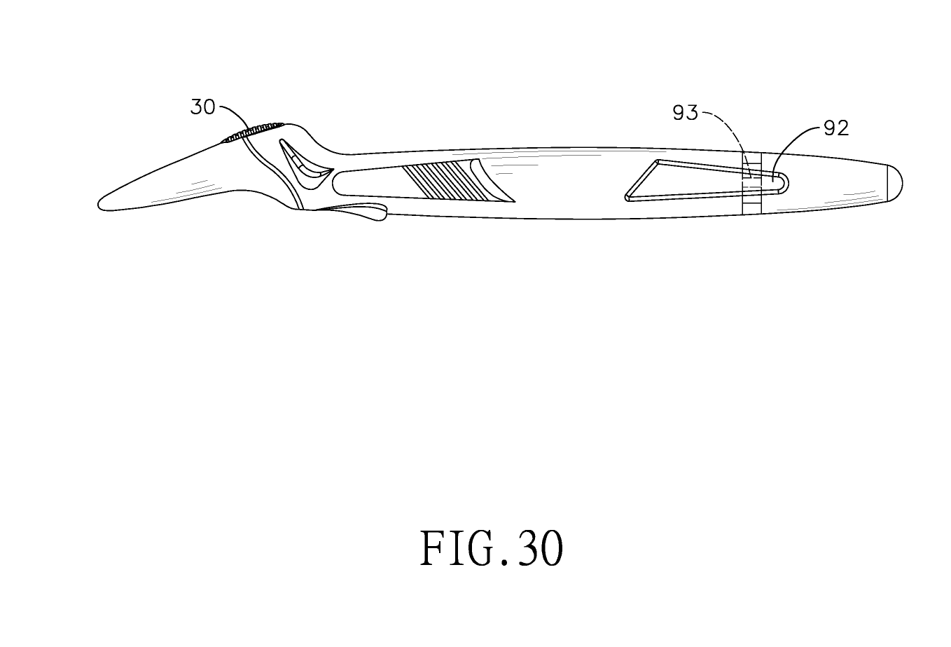

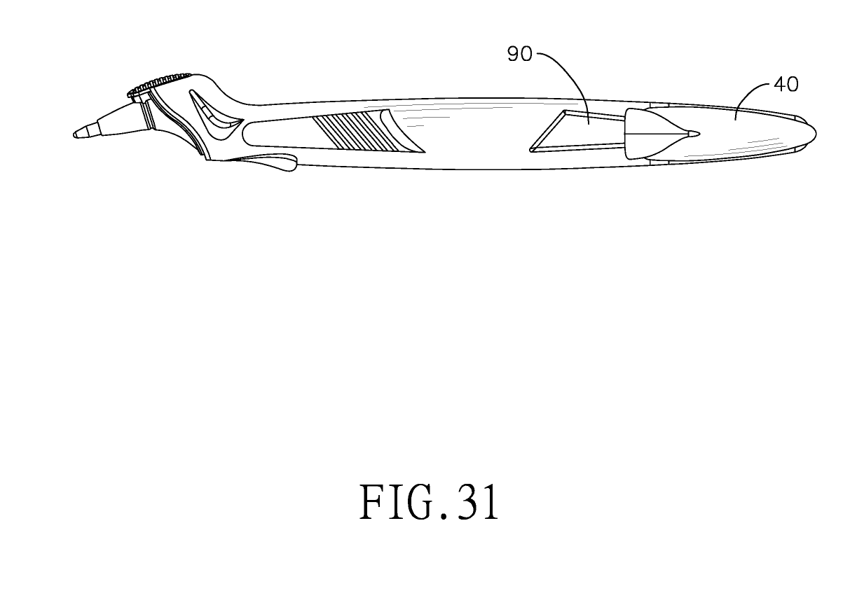

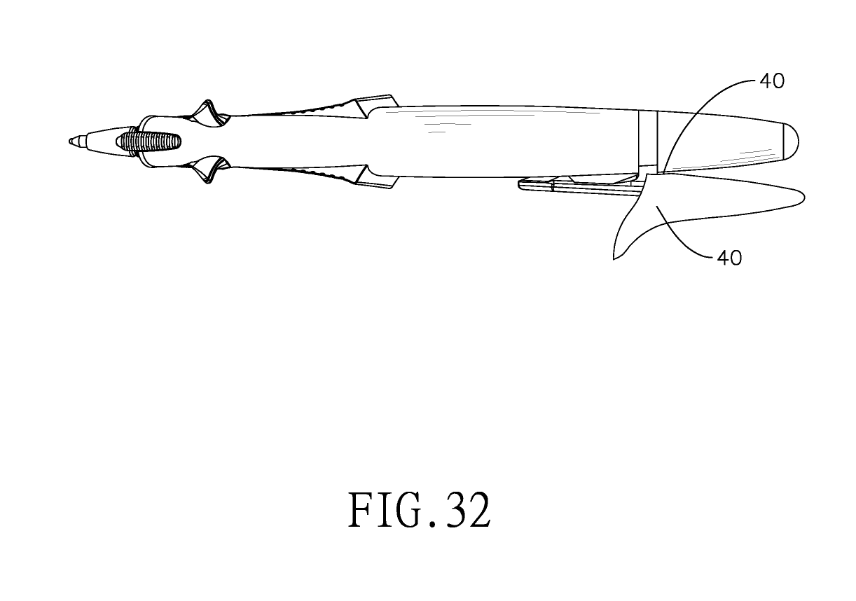

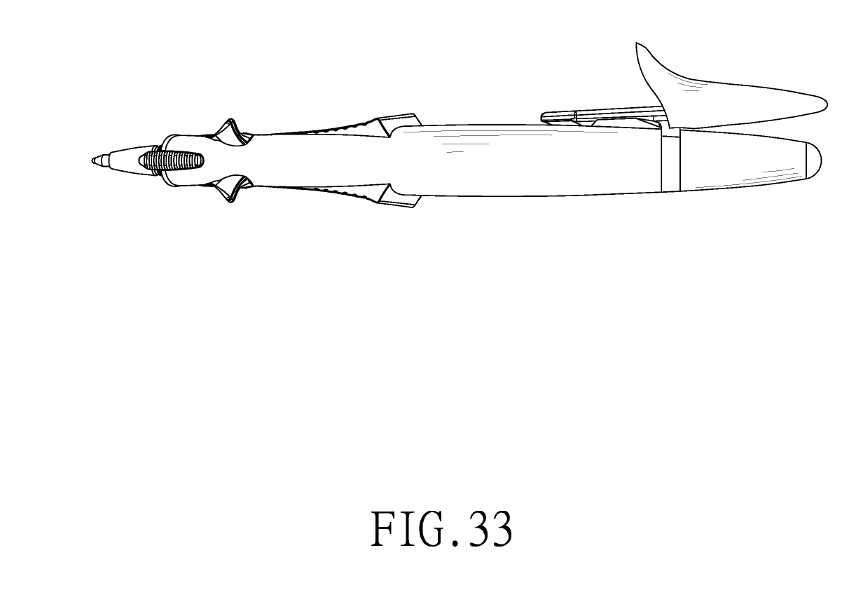

With reference to FIGS. 29 to 33, in the eighth embodiment, the breach 41 of the pen cap 40 makes the detachable clip fastener 30 detachable. A width of the breach 41 is same with a width of a shaft 93 so the pen cap 40 can be disposed not only on the pen head 10 but also on the pen clip 90. The clip part 92 can be disposed in the pen cap 40 to prevent the pen cap 40 from being left behind.

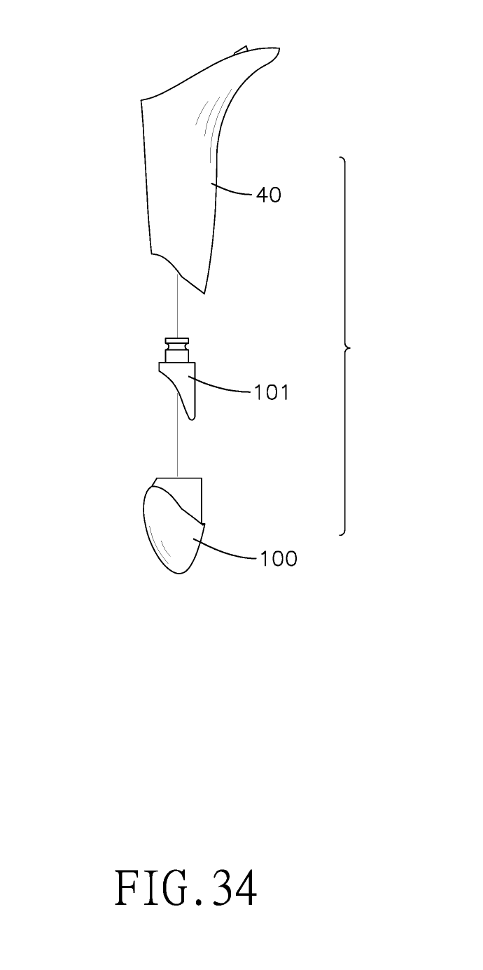

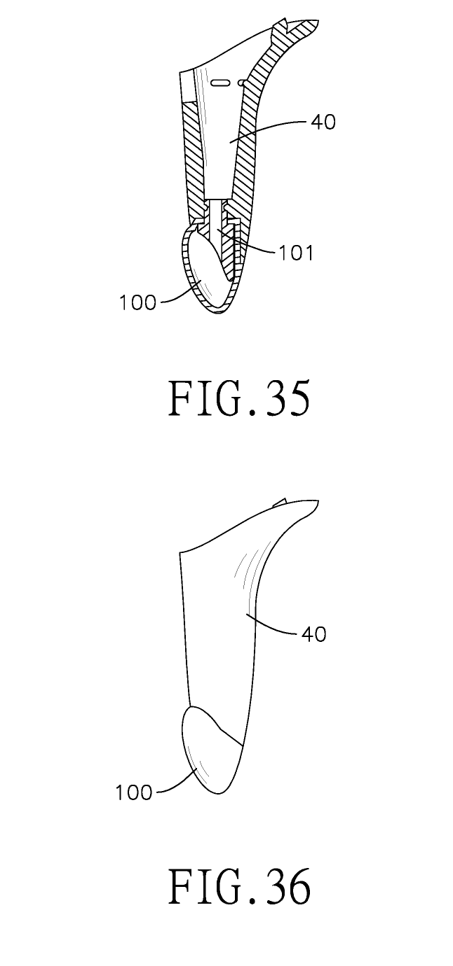

With reference to FIGS. 34 to 38, to make the easy-to-hold off-axis pen has multiple functions, the pen cap 40 of the easy-to-hold off-axis pen has a stylus part 100 which can be inducted by a touch panel. The stylus part 100 is made of a conductive material. With reference to FIGS. 34 to 36, in the embodiment, the stylus part 100 is disposed on the pen cap 40 through a connecting unit 101. One end of the connecting unit 101 is disposed in the pen cap 40 to close the pen cap 40. The other end of the connecting unit 101 is connected with the stylus part 100. Therefore, the easy-to-hold off-axis pen can be used as a stylus pen.

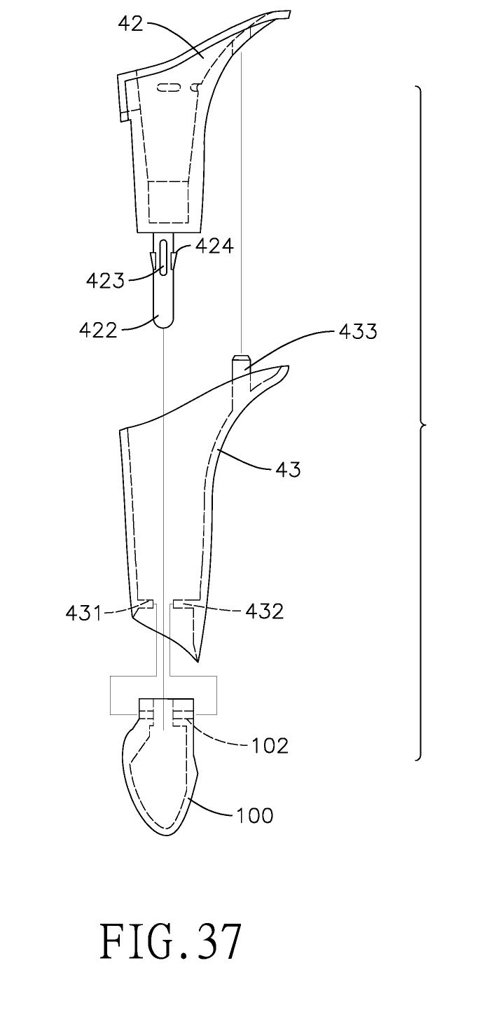

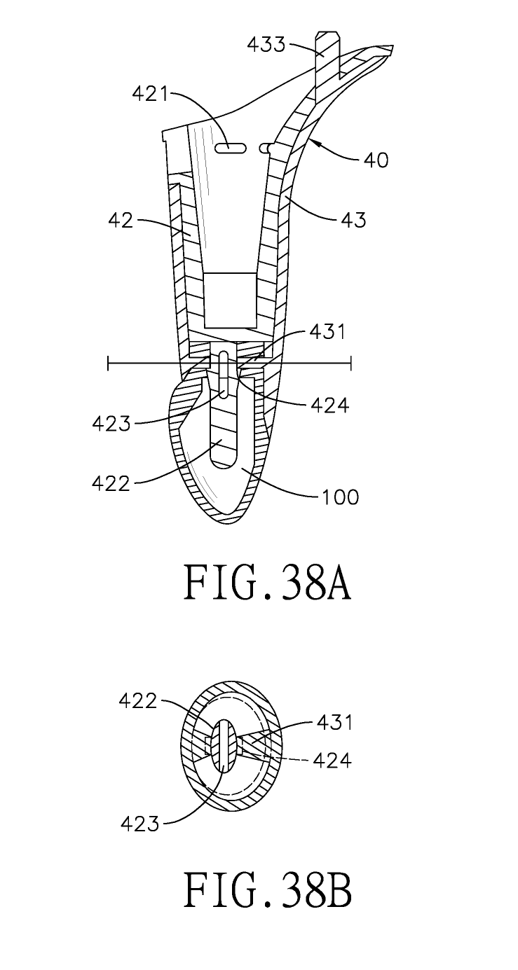

With reference to FIGS. 37 and 38, in the embodiment, the pen cap 40 includes an inner shell 42 and an outer shell 43. The inner shell 42 is disposed on the pen head 10. The inner shell 42 is hollow and has an open end and a closed end. The inner shell 42 has a button 421, a connecting stick 422, a slotted hole 423, at least two fixing units 424, and a column hole. The button 421 protrudes from the inner wall of the inner shell 42 and near the open end of the inner shell 42. The connecting stick 422 protrudes from the closed end of the inner shell 42. The slotted hole 423 is axially formed through the connecting stick 422 to make the connecting stick 422 have elasticity for compression. The at least two fixing units 424 protrude from the connecting stick 422 and near the slotted hole 423. Heights of the at least two fixing units 424 progressively decrease toward the closed end of the inner shell 42. A distance is between the fixing units 424 and the closed end of the inner shell 42. The column hole is formed in the inner shell 42. The outer shell 43 is disposed on the inner shell 42. The outer shell 43 is hollow and has two open ends. The outer shell 43 has two limiting units 431, a shrunk entrance 432, and a column 433. The limiting units 431 radially protrude from an inner wall of the outer shell 43. The shrunk entrance 432 is defined between the limiting units 431. A gap between the limiting units 431 is smaller than the maximum periphery of the fixing units 424. The column 433 protrudes from the outer shell 43 and corresponds to the column hole.

The stylus part 100 is hollow and has an open end and a closed end. The periphery of the open end is smaller than the maximum periphery of the connecting stick 422. The stylus part 100 is made of conductive material. The stylus part 100 has two recesses 102 formed on an outer wall of the stylus part 100. During assembly, the limiting units 431 are respectively disposed in the recesses 101 to make the stylus part 100 disposed on the outer shell 43. The outer shell 43 is disposed on the inner shell 42. The connecting stick 422 is disposed through the shrunk entrance 432 and makes the fixing units 424 pass through the shrunk entrance 432 to abut the limiting units 431. Due to the increasing height of the fixing units 424, the fixing units 424 can help the connecting stick 422 deform and pass through the shrunk entrance 432. Therefore, the limiting units 431 and the stylus part 100 are disposed between the fixing units 424 and the bottom of the inner shell 42.

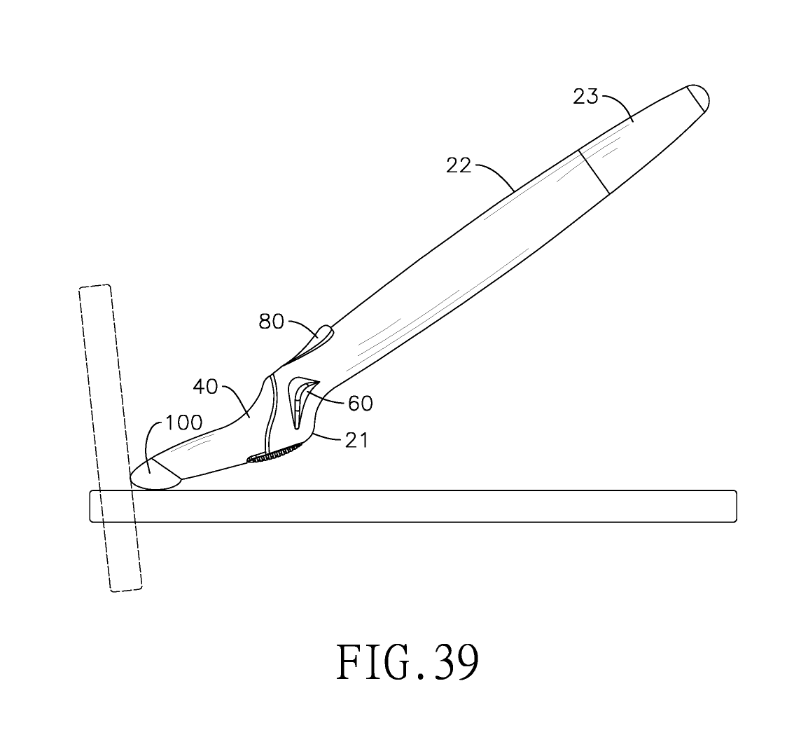

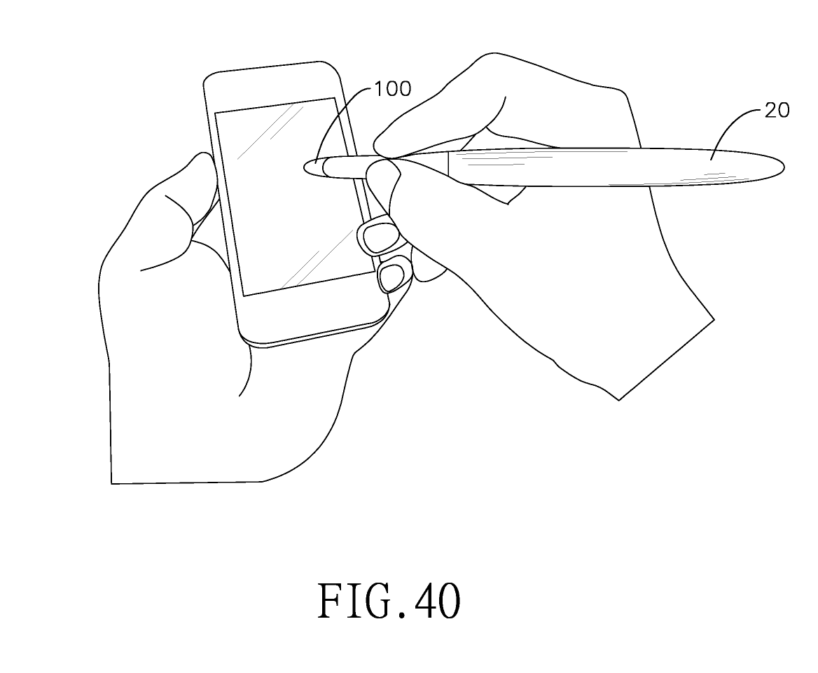

When the easy-to-hold off-axis pen is used as a stylus pen, the easy-to-hold off-axis pen can be held like holding the normal off-axis pen with the off-axis part 21 on top. The easy-to-hold off-axis pen can also be held as shown in FIGS. 39 and 40 with the off-axis part 21 on bottom. At this time, the barrel 20 abuts the purlicue, the forefinger is located on the middle finger abutment 80, and the middle finger is located on the forefinger support 60. Then, a bottom surface of the stylus part 100 can fully contact the touch panel. The stylus part 100 and the touch panel can contact via a small contact area.

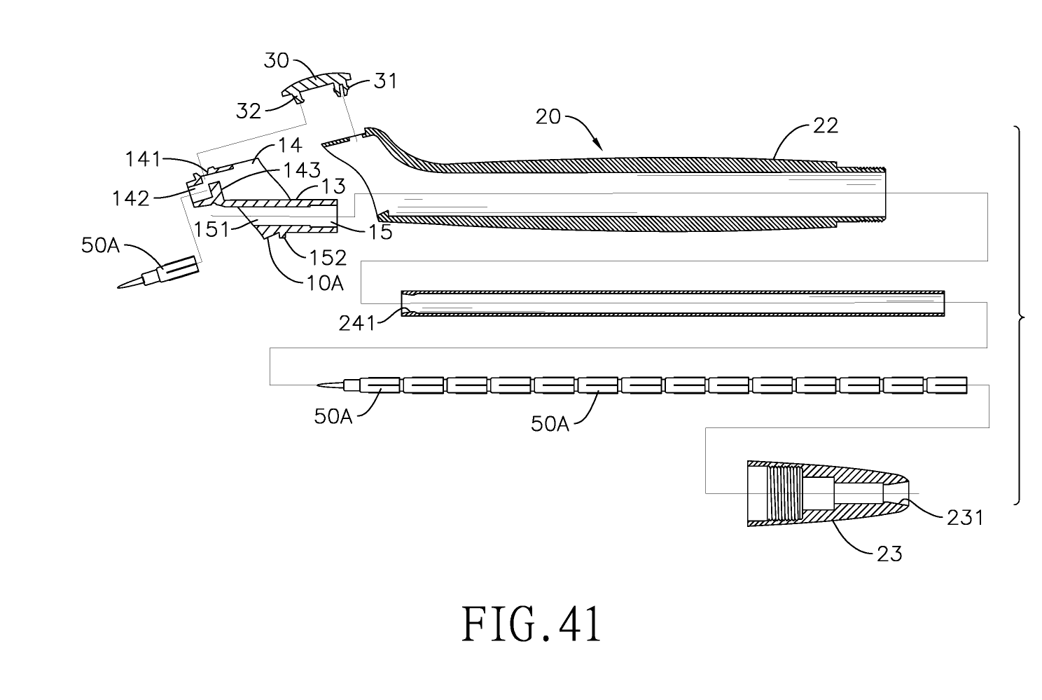

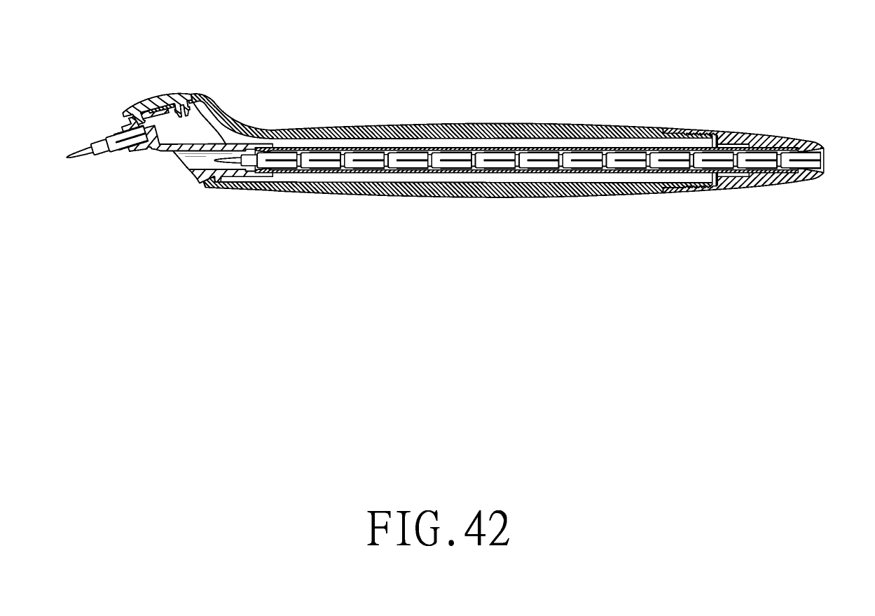

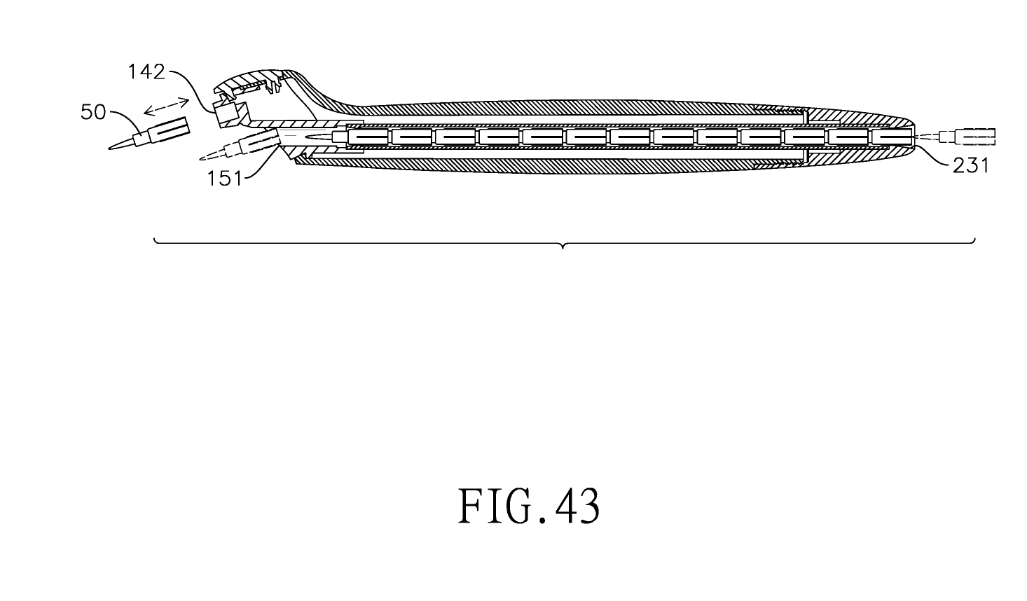

The easy-to-hold off-axis pen not only can be filled with the bending cartridge 50 but also can be filled with multiple cartridge units to act as a non-sharpening pencil. With reference to FIGS. 41 and 42, the non-sharpening pencil includes a pen head 10A, a barrel 20, a detachable clip fastener 30, and multiple cartridge units 50A. The pen head 10A is hollow and separated into a first channel 14 and a second channel 15 by a partition 13. The first channel 14 is near the protrusion 213 and communicates with the off-axis part 21. The first channel 14 has a fixing recess 141, a writing hole 142, and a block 143. The fixing recess 141 is disposed on an outer wall of the pen head 10A. The writing hole 142 is formed on the writing end 11 of the pen head 10A. The block 143 is formed on and perpendicular to the partition 13 and extends to the first channel 14. The second channel 15 is next to the first channel 14. The second channel 15 has a cartridge hole 151 and a limiting block 152. The cartridge hole 151 is next to the writing hole 142. The limiting block 152 is formed on an outer wall of the second channel 15 and corresponds to a trough of the off-axis part 21. The barrel 20 is similar to the barrel 20 of the first embodiment. The bottom part 23 has two open ends and a bottom opening 231 formed on the open end that is distal from the held part 22. The barrel 20 further has a cartridge tube 24. The cartridge tube 24 is disposed in the barrel 20 and has two open ends. The cartridge tube 24 communicates with the second channel 15. Two blocks 241 protrude from the inner wall of the cartridge tube 24. The detachable clip fastener 30 is similar to the detachable clip fastener 30 of the first embodiment. The cartridge units 50A are disposed in the cartridge tube 24. A diameter of each cartridge unit 50A is slightly longer than a diameter of the cartridge tube 24 such that multiple cartridge units 50A may be aligned. The foremost cartridge unit 50A abuts the blocks 241. The diameter of each cartridge unit 50A is slightly longer than a maximum diameter of the bottom opening 231 so that every cartridge unit 50A can be pushed in the bottom opening 231. The diameter of each cartridge unit 50A is slightly longer than a maximum diameter of the writing hole 142 to fix every cartridge unit 50A in the writing hole 142. Therefore, the pen head 10A is assembled on the barrel 20 through the detachable clip fastener 30 and the limiting block 152. With reference to FIG. 43, when the cartridge units 50A need to be replaced, first, the foremost cartridge unit 50A is picked from the writing hole 142; then, the cartridge unit 50A in the bottom opening 231 is pushed into the cartridge tube 24. Other cartridge units 50A will be pushed forward and closer to the cartridge hole 151 and one cartridge unit 50A will be pushed out from the cartridge hole 151. Finally, the pushed-out cartridge unit 50A is disposed in the writing hole 142. The replacing process does not need to detach the detachable clip fastener 30 and the barrel 20, and thereby is easy and convenient.

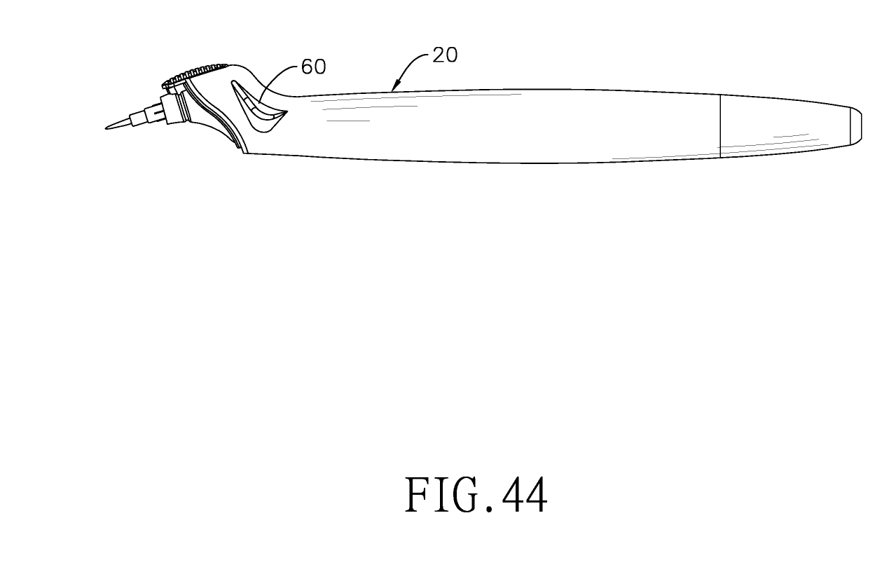

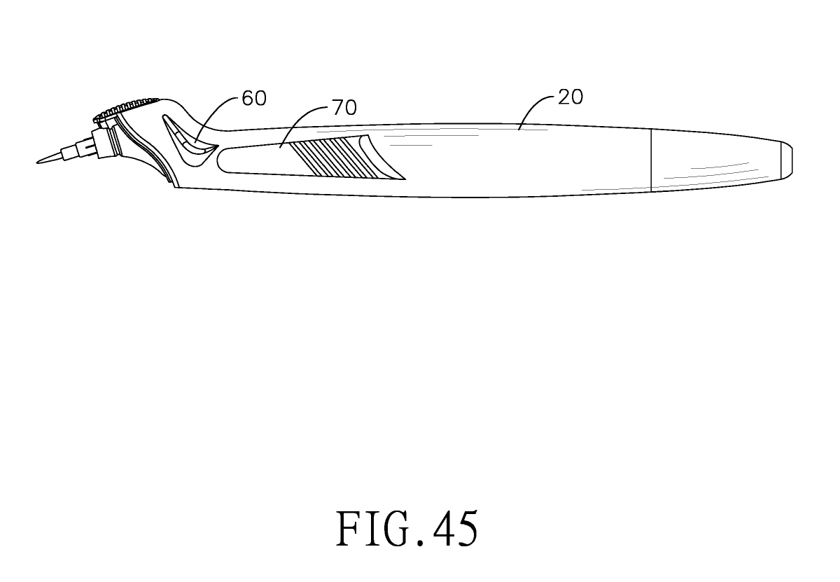

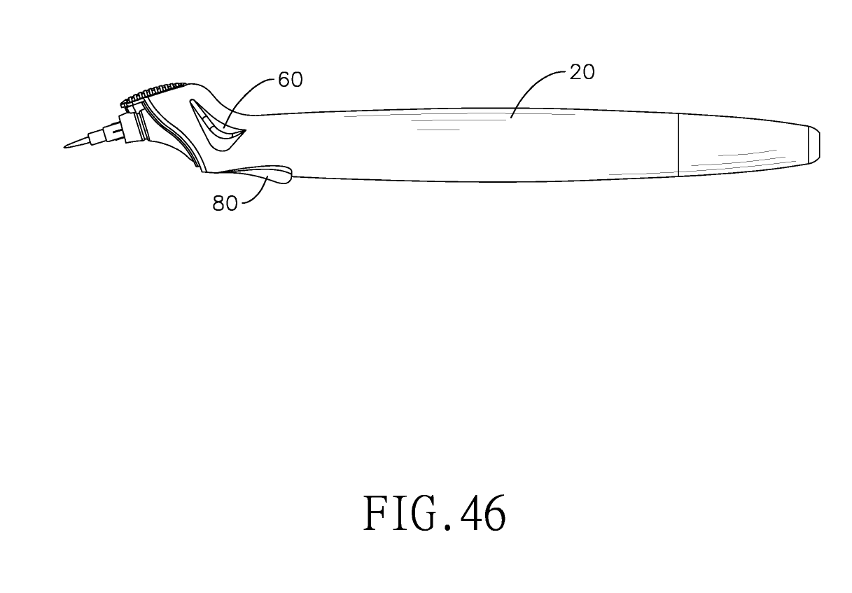

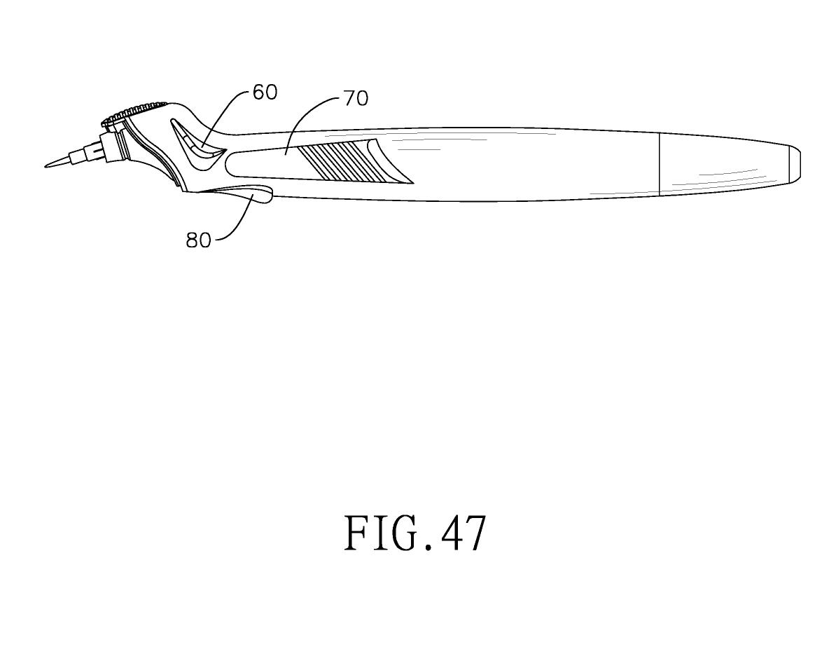

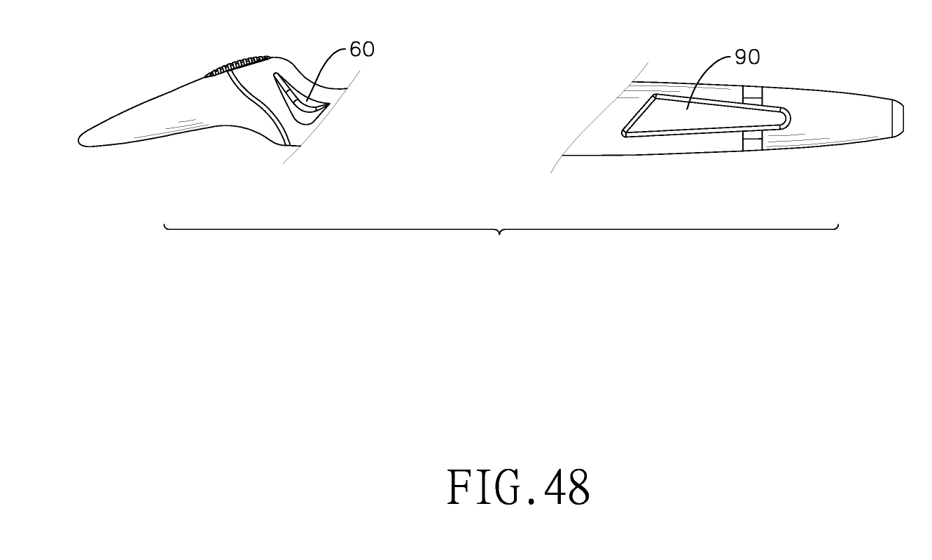

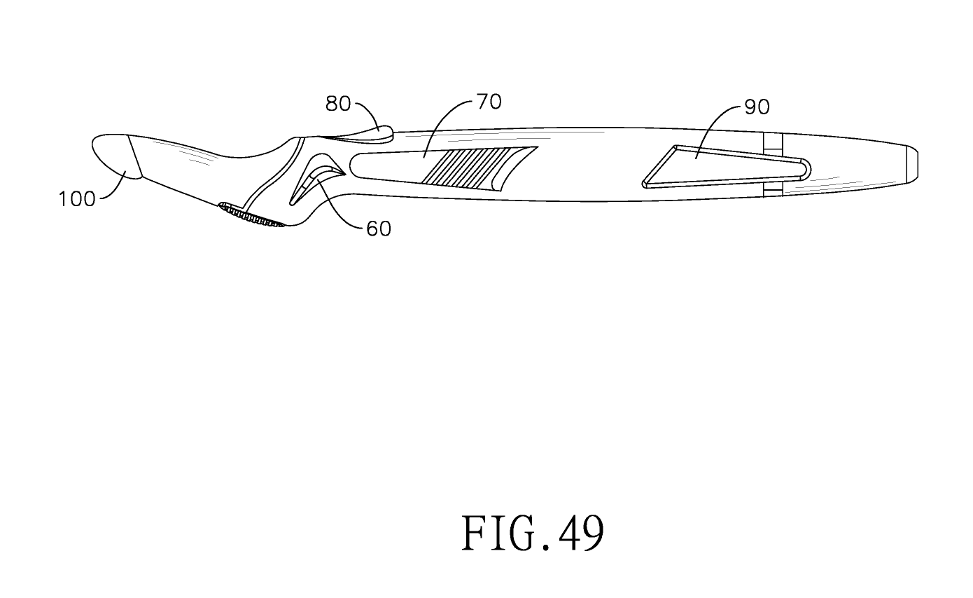

To make the non-sharpening pencil easy to hold, the forefinger support 60, the thumb anti-slip part 70, and the middle finger abutment 80 similar to the first embodiment can be disposed on the non-sharpening pencil. With reference to FIG. 44, two forefinger supports 60 are respectively disposed on two bilateral sides of the barrel 20. With reference to FIG. 45, two forefinger supports 60 and two thumb anti-slip parts 70 are respectively disposed on the two bilateral sides of the barrel 20. With reference to FIG. 46, two forefinger supports 60 are respectively disposed on the two bilateral sides of the barrel 20 and the middle finger abutment 80 is disposed on the barrel 20. With reference to FIG. 47, two forefinger supports 60 and two thumb anti-slip parts 70 are respectively disposed on the two bilateral sides of the barrel 20 and the middle finger abutment 80 is disposed on the barrel 20. With reference to FIG. 48, two forefinger supports 60 are respectively disposed on the two bilateral sides of the barrel 20 and a pen clip 90 is disposed between the held part 22 and the bottom part 23. With reference to FIG. 49, besides the forefinger support 60, the thumb anti-slip part 70, the middle finger abutment 80, and the pen clip 90, a stylus part 100 is further disposed on the bottom of the pen cap 40. The forefinger support 60, the thumb anti-slip part 70, and the middle finger abutment 80 may be disposed on the two bilateral sides of the barrel 20 or disposed on one side of the barrel 20 according to demand.

The forefinger support 60, the thumb anti-slip part 70, and the middle finger abutment 80 can be selectively disposed according to demand, bilaterally disposed on the two bilateral sides of the barrel 20, or singly disposed on one side of the barrel 20 specifically for right-handed users or left-handed users.

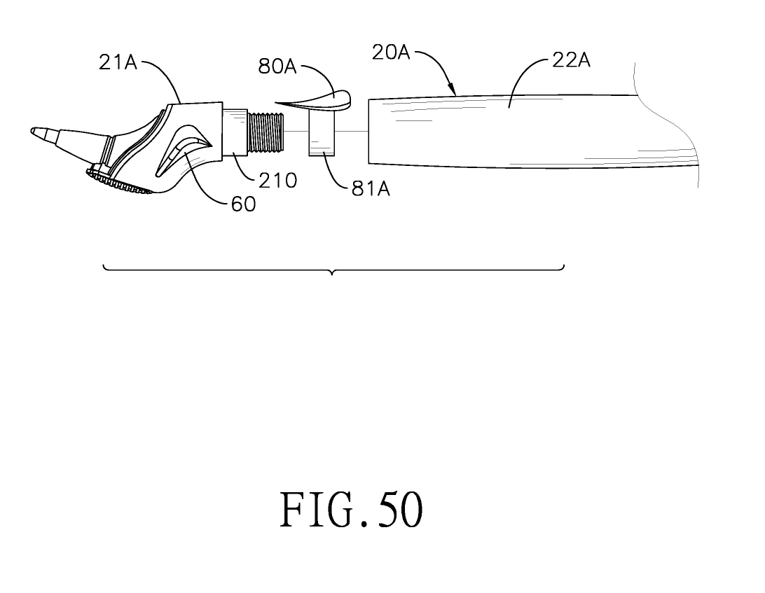

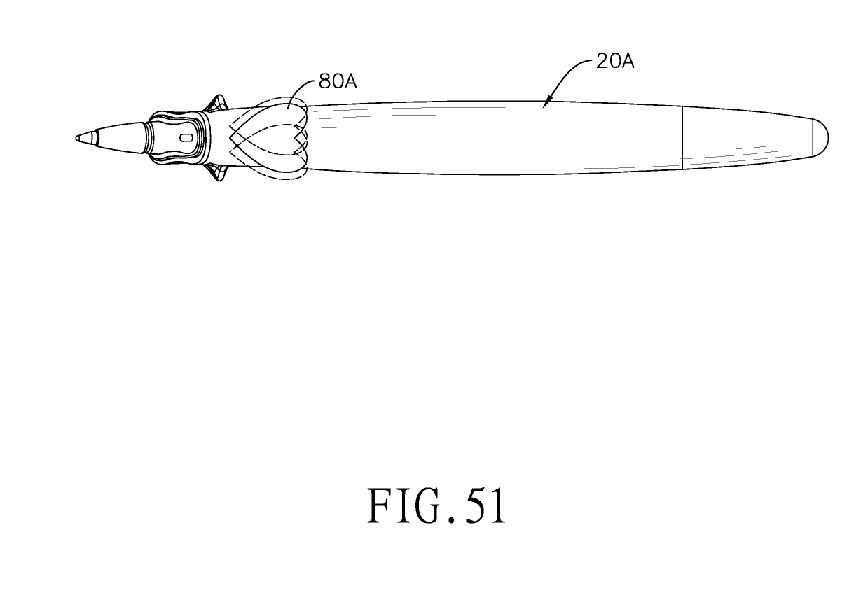

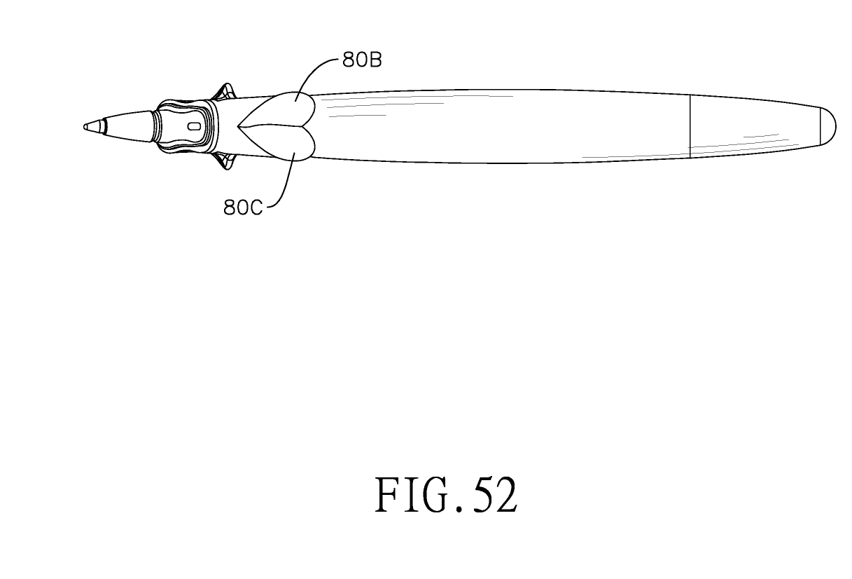

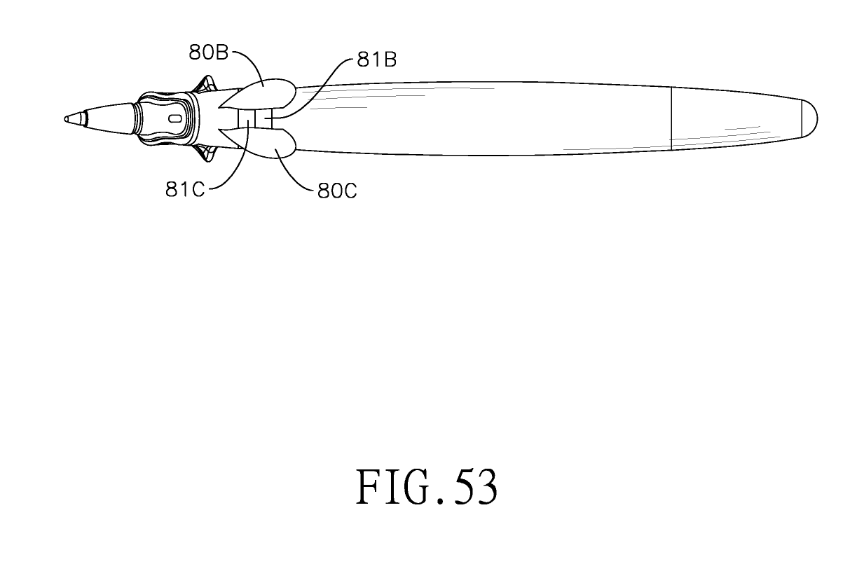

The middle finger abutment 80, the held part 22, and the off-axis part 21 illustrated in the above embodiments are integral, in addition to those that also can be disposed detachably. With reference to FIGS. 50 and 51, the held part 22A, the off-axis part 21A, and the forefinger support 60 are detachable. The forefinger support 60 is disposed on the off-axis part 21A. The off-axis part 21A and the held part 22A respectively have a corresponding screw rod 210 and a screw hole (not shown). The screw rod 210 can be disposed on the off-axis part 21 or the held part 22. An outer diameter of the screw rod 210 is smaller than an outer diameter of the off-axis part 21. The middle finger abutment 80A is disposed on a ring 81A and the ring 81A is disposed on the screw rod 210. When in use, the ring 81A can rotate to adjust the location of the middle finger abutment 80A as shown in FIG. 51. Besides, with reference to FIG. 52, two middle finger abutments 80B, 80C are respectively disposed on two rings 81B, 81C. The middle finger abutments 80B, 80C can be assembled to form a shape of a heart and can be separated like a broken heart. The middle finger abutments 80B, 80C are not only creative but also adjustable according to demand of user.

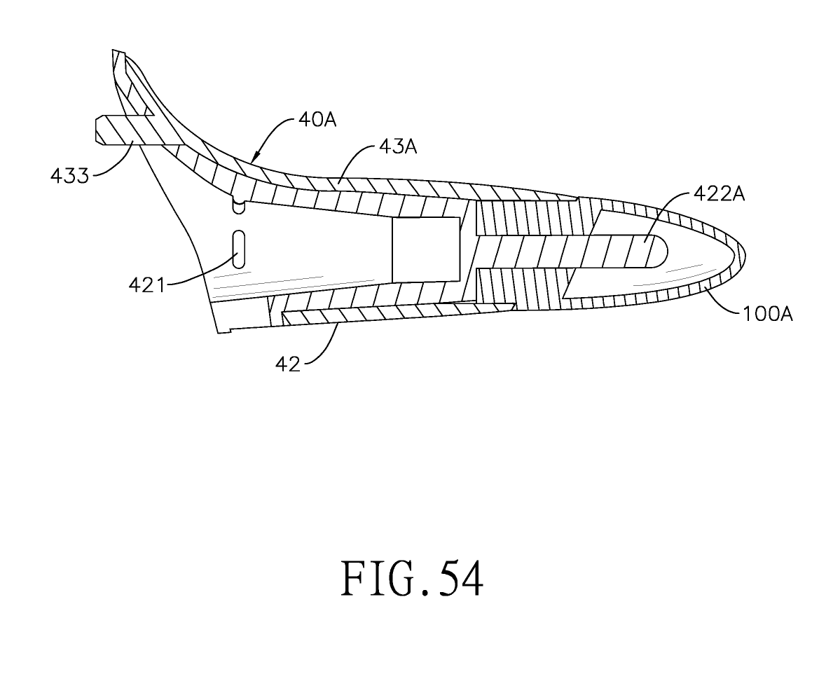

The sectional side view of another pen cap 40A is shown in FIG. 54. A soft plastic stylus part 100A is adhered on the connecting stick 422A and the outer shell 43A, instead of being disposed in corresponding shapes mentioned above. The stylus part 100A has a hole to accommodate the connecting stick 422A to prevent the stylus part 100A from deforming due to the aggressive force applied on the stylus part 100A.

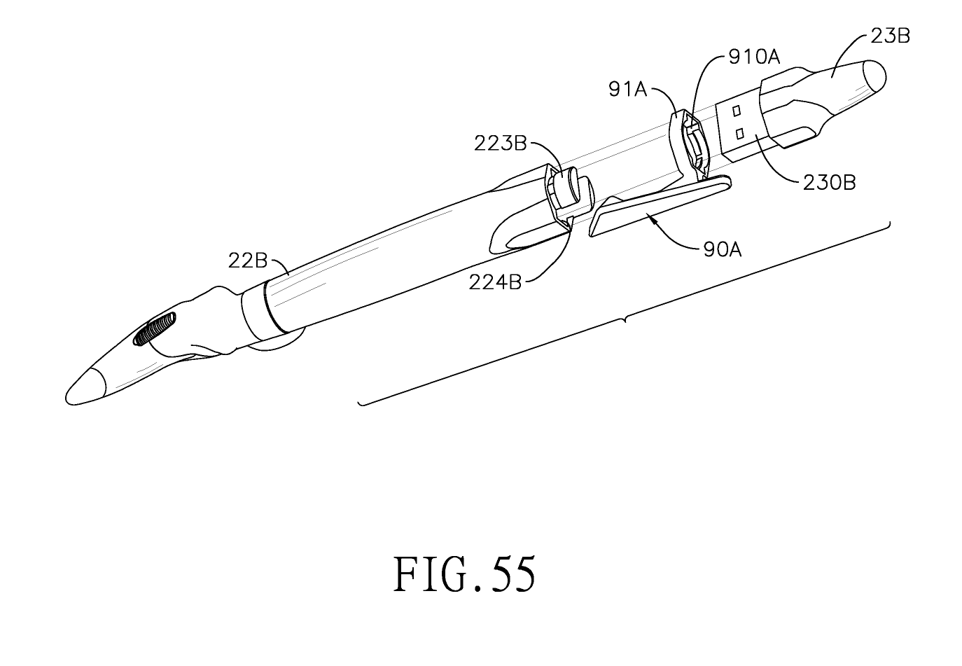

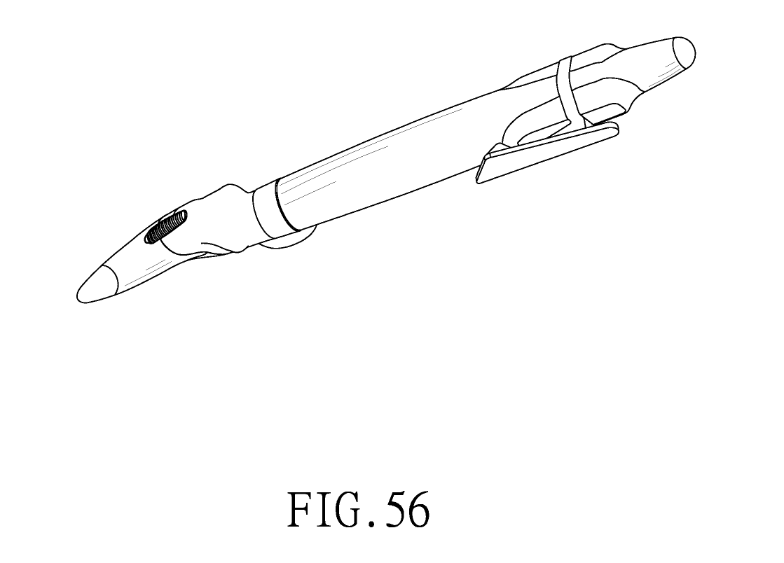

With reference to FIGS. 55 and 56, a universal serial bus (USB) flash drive 230B is disposed on the bottom part 23B. Two fixing blocks 223B protrude from the end of the held part 22B connected with the bottom part 23B. A USB socket 224B is formed between the fixing blocks 223B. The pen clip 90A is disposed on the fixing blocks 223B through a pen clip ring 91A. An inner wall of the pen clip ring 91A is axially depressed to form two troughs 910A. The USB flash drive 230B is disposed in the trough 910A of the pen clip ring 91A and is located between the fixing blocks 223B, thereby forming the easy-to-hold off-axis pen having the USB flash drive and being easy to carry and hard to be left behind.

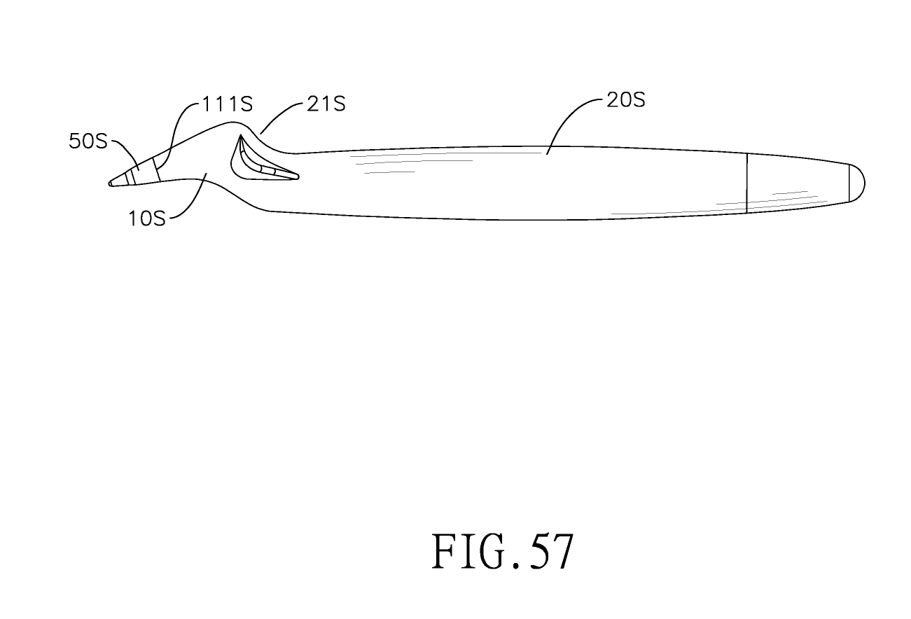

With reference to FIG. 57, the pen head 10S, the barrel 20S, and the off-axis part 21S can be formed integrally by 3D printing. The cartridge 50S can be pushed into the barrel 20S.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

1-39. (canceled)

40. An easy-to-hold off-axis pen comprising:
a pen head being hollow;
a barrel being hollow and tubular and connected with the pen head; the barrel having an off-axis part, a held part, and a bottom part; an end of the off-axis part disposed on the pen head; a protrusion formed on an end of the off-axis part opposite to the pen head; the held part disposed on the off-axis part near the protrusion; the held part and the off-axis part being in different axes; the bottom part disposed on the held part opposite to the off-axis part; and
at least one forefinger support formed on a sidewall of the off-axis part and extending obliquely.

41. The easy-to-hold off-axis pen as claimed in claim 40, wherein at least one middle finger abutment is disposed on the barrel and located on a junction of the off-axis part and the held part; the at least one middle finger abutment is formed backwardly relative to the protrusion.

42. The easy-to-hold off-axis pen as claimed in claim 41, wherein the at least one middle finger abutment comprises two middle finger abutments; the middle finger abutments are assembled with each other and respectively tilted in two directions.

43. The easy-to-hold off-axis pen as claimed in claim 42, wherein the off-axis part of the barrel and the held part of the barrel are detachable; the at least one forefinger support is disposed on the off-axis part; at least one ring is disposed between the off-axis part and the held part; the middle finger abutments are disposed on the ring.

44. The easy-to-hold off-axis pen as claimed in claim 41, wherein a surface of each one of the at least one middle finger abutment is concave.

45. The easy-to-hold off-axis pen as claimed in claim 42, wherein a surface of each one of the at least one middle finger abutment is concave.

46. The easy-to-hold off-axis pen as claimed in claim 43, wherein a surface of each one of the at least one middle finger abutment is concave.

47. The easy-to-hold off-axis pen as claimed in claim 43, wherein the at least one ring comprises two rings; the at least one middle finger abutment comprises two middle finger abutments; the middle finger abutments are respectively disposed on the rings; the middle finger abutments combine to form a shape of a heart.

48. The easy-to-hold off-axis pen as claimed in claim 40, wherein at least one thumb anti-slip part is formed on the barrel; the at least one thumb anti-slip part extends from an end of the off-axis part connected with the held part and extends toward the held part; a thickness of the thumb anti-slip part and a width of the thumb anti-slip part increase along a direction toward the held part.

49. The easy-to-hold off-axis pen as claimed in claim 41, wherein at least one thumb anti-slip part is formed on the barrel; the at least one thumb anti-slip part extends from an end of the off-axis part connected with the held part and extends toward the held part; a thickness of the thumb anti-slip part and a width of the thumb anti-slip part increase along a direction toward the held part.

50. The easy-to-hold off-axis pen as claimed in claim 42, wherein at least one thumb anti-slip part is formed on the barrel; the at least one thumb anti-slip part extends from an end of the off-axis part connected with the held part and extends toward the held part; a thickness of the thumb anti-slip part and a width of the thumb anti-slip part increase along a direction toward the held part.

51. The easy-to-hold off-axis pen as claimed in claim 40, wherein an opening is formed through the pen head; the pen head has a writing end and a connecting end; a sectional area of the connecting end is larger than a sectional area of the writing end; a peripheral edge is formed on the pen head; the off-axis part of the barrel is disposed on the connecting end of the pen head and abuts the peripheral edge; a projection is formed on an outer wall of the pen head; an aperture is formed on the projection communicating with the opening; a hole is formed through the off-axis part and communicates with a hollow part of the off-axis part; and
a detachable clip fastener is detachably disposed on the barrel and the pen head; the detachable clip fastener has a locating bump and a fixing bump which are opposite on two ends of the detachable clip fastener; the locating bump and the fixing bump are respectively disposed on the aperture of the projection and the hole of the off-axis part.

52. The easy-to-hold off-axis pen as claimed in claim 40, wherein a pen cap is disposed on the pen head; the pen cap has an open end which accommodates the pen head; a stylus part is disposed on another end of the pen cap opposite to the open end.

53. The easy-to-hold off-axis pen as claimed in claim 52, wherein the pen cap has an outer shell and an inner shell; the outer shell is hollow and two-end open; the inner shell is disposed in the outer shell; the stylus part is hollow and has an open end; the open end of the stylus part faces the pen cap and is disposed on the outer shell.

54. The easy-to-hold off-axis pen as claimed in claim 48, wherein a pen clip is disposed on the barrel to make the easy-to-hold off-axis pen clipped on pockets of clothes.

55. The easy-to-hold off-axis pen as claimed in claim 49, wherein a pen clip is disposed on the barrel to make the easy-to-hold off-axis pen clipped on pockets of clothes.

56. The easy-to-hold off-axis pen as claimed in claim 50, wherein a pen clip is disposed on the barrel to make the easy-to-hold off-axis pen clipped on pockets of clothes.

57. The easy-to-hold off-axis pen as claimed in claim 54, wherein the bottom part has a universal serial bus (USB) flash drive; a USB socket corresponding to the USB flash drive is formed on the held part of the barrel.

58. The easy-to-hold off-axis pen as claimed in claim 55, wherein the bottom part has a universal serial bus (USB) flash drive; a USB socket corresponding to the USB flash drive is formed on the held part of the barrel.

59. The easy-to-hold off-axis pen as claimed in claim 56, wherein the bottom part has a universal serial bus (USB) flash drive; a USB socket corresponding to the USB flash drive is formed on the held part of the barrel.

60. The easy-to-hold off-axis pen as claimed in claim 40, wherein a curved surface is formed on the at least one forefinger support and the protrusion of the off-axis part.

61. An easy-to-hold off-axis pen comprising:
a pen head being hollow;
a barrel being hollow and tubular and connected with the pen head; the barrel having an off-axis part, a held part, and a bottom part; an end of the off-axis part disposed on the pen head; a protrusion formed on an end of the off-axis part opposite to the pen head; the held part disposed on the off-axis part near the protrusion; the held part and the off-axis part being in different axes; the bottom part disposed on the held part opposite to the off-axis part;
at least one middle finger abutment disposed on the barrel and located on a junction of the off-axis part and the held part; the at least one middle finger abutment formed backwardly relative to the protrusion.

62. The easy-to-hold off-axis pen as claimed in claim 61, wherein the at least one middle finger abutment comprises two middle finger abutments; the middle finger abutments are assembled with each other and respectively tilted in two directions.

63. The easy-to-hold off-axis pen as claimed in claim 62, wherein the off-axis part of the barrel and the held part of the barrel are detachable; at least one ring is disposed between the off-axis part and the held part; the middle finger abutments are disposed on the at least one ring.

64. The easy-to-hold off-axis pen as claimed in claim 61, wherein a surface of each of the at least one middle finger abutment is concave.

65. The easy-to-hold off-axis pen as claimed in claim 62, wherein a surface of each of the at least one middle finger abutment is concave.

66. The easy-to-hold off-axis pen as claimed in claim 63, wherein a surface of each of the at least one middle finger abutment is concave.

67. The easy-to-hold off-axis pen as claimed in claim 62, wherein the at least one ring comprises two rings; the two middle finger abutments are respectively disposed on the two rings; the middle finger abutments are assembled to form a shape of a heart.

68. The easy-to-hold off-axis pen as claimed in claim 61, wherein the at least one forefinger support is formed on a sidewall of the off-axis part and extends obliquely to support forefingers.

69. The easy-to-hold off-axis pen as claimed in claim 68, wherein a curved surface is formed on the at least one forefinger support and the protrusion of the off-axis part.

70. The easy-to-hold off-axis pen as claimed in claim 61, wherein at least one thumb anti-slip part is formed on the barrel; the at least one thumb anti-slip part extends from an end of the off-axis part connected with the held part and extends toward the held part; a thickness of the thumb anti-slip part and a width of the thumb anti-slip part increase along a direction toward the held part.

71. The easy-to-hold off-axis pen as claimed in claim 68, wherein at least one thumb anti-slip part is formed on the barrel; the at least one thumb anti-slip part extends from an end of the off-axis part connected with the held part and extends toward the held part; a thickness of the thumb anti-slip part and a width of the thumb anti-slip part increase along a direction toward the held part.

72. The easy-to-hold off-axis pen as claimed in claim 61, wherein an opening is formed through the pen head; the pen head has a writing end and a connecting end; a sectional area of the connecting end is larger than a sectional area of the writing end; a peripheral edge is formed on the pen head; the off-axis part of the barrel is disposed on the connecting end of the pen head and abuts the peripheral edge; a projection is formed on the pen head; an aperture is formed on the projection and communicates with the opening; a hole is formed through the off-axis part and communicates with a hollow part of the off-axis part; and
a detachable clip fastener is detachably disposed on the barrel and the pen head; the detachable clip fastener has a locating bump and a fixing bump which are opposite on two ends of the detachable clip fastener; the locating bump and the fixing bump are respectively disposed in the aperture of the projection and the hole of the off-axis part.

73. The easy-to-hold off-axis pen as claimed in claim 61, wherein a pen cap is disposed on the pen head; the pen cap has an open end which accommodates the pen head; a stylus part is disposed on another end of the pen cap opposite the open end.

74. The easy-to-hold off-axis pen as claimed in claim 73, wherein the pen cap has an outer shell and an inner shell; the outer shell is hollow and two-end open; the inner shell is disposed in the outer shell; the stylus part is hollow and has an open end; the open end of the stylus part faces the pen cap and is disposed on the outer shell.

75. The easy-to-hold off-axis pen as claimed in claim 69, wherein a pen clip is disposed on the barrel to make the easy-to-hold off-axis pen clipped on pockets of clothes.

76. The easy-to-hold off-axis pen as claimed in claim 61, wherein the bottom part has a USB flash drive; a USB socket corresponding to the USB flash drive is formed on the held part of the barrel.

77. An easy-to-hold off-axis pen comprising:
a pen head being hollow;
a barrel being hollow and tubular and connected with the pen head; the barrel having an off-axis part, a held part, and a bottom part; an end of the off-axis part disposed on the pen head; a protrusion formed on an end of the off-axis part opposite to the pen head; the held part disposed on the off-axis part near the protrusion; the held part and the off-axis part being in different axes; the bottom part disposed on the held part opposite to the off-axis part; and
at least one thumb anti-slip part disposed on the barrel; the at least one thumb anti-slip part extending from an end of the off-axis part connected with the held part and extending toward the held part; a thickness of the thumb anti-slip part and a width of the thumb anti-slip part increasing along a direction toward the held part.

78. The easy-to-hold off-axis pen as claimed in claim 77, wherein at least one middle finger abutment is disposed on the barrel and located on a junction of the off-axis part and the held part; the at least one middle finger abutment is formed backwardly relative to the protrusion.

79. The easy-to-hold off-axis pen as claimed in claim 78, wherein the at least one middle finger abutment comprises two middle finger abutments; the middle finger abutments are assembled with each other and respectively tilted in two directions.

80. The easy-to-hold off-axis pen as claimed in claim 79, wherein the off-axis part of the barrel and the held part of the barrel are detachable; at least one ring is disposed between the off-axis part and the held part; the middle finger abutments are disposed on the ring.

81. The easy-to-hold off-axis pen as claimed in claim 77, wherein a surface of each of the at least one middle finger abutment is concave.

82. The easy-to-hold off-axis pen as claimed in claim 78, wherein a surface of each of the at least one middle finger abutment is concave.

83. The easy-to-hold off-axis pen as claimed in claim 79, wherein a surface of each of the at least one middle finger abutment is concave.

84. The easy-to-hold off-axis pen as claimed in claim 80, wherein the at least one ring comprises two rings; the two middle finger abutments are respectively disposed on the two rings; the middle finger abutments are assembled to form a shape of a heart.

85. The easy-to-hold off-axis pen as claimed in claim 77, wherein at least one forefinger support is formed on a sidewall of the off-axis part and extends obliquely to support forefingers.

86. The easy-to-hold off-axis pen as claimed in claim 78, wherein at least one forefinger support is formed on a sidewall of the off-axis part and extends obliquely to support forefingers.

87. The easy-to-hold off-axis pen as claimed in claim 85, wherein a curved surface is formed on the at least one forefinger support and the protrusion of the off-axis part.

88. The easy-to-hold off-axis pen as claimed in claim 86, wherein a curved surface is formed on the at least one forefinger support and the protrusion of the off-axis part.

89. The easy-to-hold off-axis pen as claimed in claim 77, wherein an opening is formed through the pen head; the pen head has a writing end and a connecting end; a sectional area of the connecting end is larger than a sectional area of the writing end; a peripheral edge is formed on the pen head; the off-axis part of the barrel is disposed on the connecting end of the pen head and abuts the peripheral edge; a projection is formed on the pen head; an aperture is formed on the projection and communicates with the opening; a hole is formed through the off-axis part and communicates with a hollow part of the off-axis part; a detachable clip fastener is detachably disposed on the barrel and the pen head; the detachable clip fastener has a locating bump and a fixing bump which are opposite on two ends of the detachable clip fastener; the locating bump and the fixing bump are respectively disposed on the aperture of the projection and the hole of the off-axis part.

90. The easy-to-hold off-axis pen as claimed in claim 77, wherein a pen cap is disposed on the pen head; the pen cap has an open end which accommodates the pen head; a stylus part is disposed on another end of the pen cap opposite to the open end.

91. The easy-to-hold off-axis pen as claimed in claim 90, wherein the pen cap has an outer shell and an inner shell; the outer shell is hollow and two-end open; the inner shell is disposed in the outer shell; the stylus part is hollow and has an open end; the open end of the stylus part faces the pen cap and is disposed on the outer shell.

92. The easy-to-hold off-axis pen as claimed in claim 85, wherein a pen clip is disposed on the barrel to make the easy-to-hold off-axis pen clipped on pockets of clothes.

93. The easy-to-hold off-axis pen as claimed in claim 86, wherein a pen clip is disposed on the barrel to make the easy-to-hold off-axis pen clipped on pockets of clothes.

94. The easy-to-hold off-axis pen as claimed in claim 77, wherein the bottom part has a USB flash drive; a USB socket corresponding to the USB flash drive is formed on the held part of the barrel.
